(19) United States
(12) Patent Application Publication
(10) Pub. No.: US 2013/0131344 A1
(43) Pub. Date: May 23, 2013

(54) ORGANO-METALLIC FRAMEWORKS DERIVED FROM CARBENOPHILIC METALS AND METHODS OF MAKING SAME

(71) Applicants: Omar M. Yaghi, Berkeley, CA (US); Alexander U. Czaja, Freinsheim (DE); Kounosuke Oisaki, Bunkyo-ku (JP)

(72) Inventors: Omar M. Yaghi, Berkeley, CA (US); Alexander U. Czaja, Freinsheim (DE); Kounosuke Oisaki, Bunkyo-ku (JP)

(73) Assignees: BASF SE, Ludwigshafen (DE); THE REGENTS OF THE UNIVERSITY OF CALIFORNIA, Oakland, CA (US)

(21) Appl. No.: 13/578,579

(22) PCT Filed: Feb. 12, 2011
(86) PCT No.: PCT/US2011/024671

§ 371 Date: Nov. 7, 2012

Related U.S. Application Data
(60) Provisional application No. 61/304,300, filed on Feb. 12, 2010.

(30) Foreign Application Priority Data
Jun. 19, 2010 (US) PCT/US10/39284

(51) Int. Cl. C07F 15/00

(52) U.S. Cl. CPC C07F 15/006
USPC 546/2

(57) ABSTRACT

The disclosure provides organic frameworks comprising increased stability.

### CROSS REFERENCE TO RELATED APPLICATIONS

This application claims priority under 35 U.S.C. §119 from Provisional Application Ser. Nos. 61/304,300, filed Feb. 12, 2010, and PCT/US10/39284, filed Jun. 19, 2010, the disclosures of which are incorporated herein by reference.

### STATEMENT REGARDING FEDERALLY SPONSORED RESEARCH

This invention was made with Government support under Grant No. W911NF-06-1-0405, awarded by the United States Army, Army Research Office. The Government has certain rights in this invention.

### TECHNICAL FIELD

The disclosure provides organometallic frameworks for gas separation, storage, and for use as sensors with chemical stability.

### BACKGROUND

Frameworks for gas separation, storage and purification are important.

### SUMMARY

The disclosure provides chemically stable open frameworks comprising designated elements including, but not limited to, zirconium, titanium, aluminum, and magnesium ions. The disclosure encompasses all open framework materials that are constructed from organic links bridged by monodentate and/or multidentate organic or inorganic cores. Including all classes of open framework materials; covalent organic frameworks (COFs); zeolitic imidazolate frameworks (ZIFs); metal organic frameworks (MOFs); and all possible net topologies as described in or resulting from the reticular chemistry structure resource (http:(//)rcsr.anu.edu.au/). The disclosure provides for chemically stable open frameworks that can be used in industry. Such frameworks can be used in a variety of applications, including, but not limited to, gas storage and separation, chemical and biological sensing, molecular reorganization and catalysis.

The disclosure provides an organo-metallic framework comprising the general structure M-L-M, wherein M is a framework metal and wherein L is a linking moiety having a heterocyclic carbene linked to a modifying metal. In yet a further embodiment, the linking moiety comprises an N-heterocyclic carbene. In one embodiment, the framework comprises a covalent organic framework (COF), a zeolitic imidizole framework (ZIF), or a metal organic framework (MOF). In a further embodiment, the framework metal is selected from the group including, but not limited to, Li, Na, Rb, Mg, Ca, Sr, Ba, Sc, Ti, Zr, Ta, Cr, Mo, W, Mn, Fe, Ru, Os, Co, Ni, Pd, Pt, Cu, Au, Zn, Al, Ga, In, Si, Ge, Sn, and Bi. In yet another embodiment, the modifying metal is selected from the group consisting of Li, Be, Na, Mg, Al, Si, K, Ca, Ti, V, Cr, Mn, Fe, Co, Ni, Cu, Zn, Ga, Ge, Sr, Y, Zr, Nb, Mo, Ru, Rh, Pd, Ag, Sn, Te, Ba, Hf, Ta, W, Re, Os, Ir, Pt, Au, Hg, Sm, Eu, and Yb. In certain embodiments, the modifying metal extends into a pore of the framework. In some embodiments the framework comprises a guest species, however, in other embodiments, the framework lacks a guest species.

The disclosure provides a method of making an organo-metallic framework described above comprising reacting a linking moiety comprising a heterocyclic carbene and comprising a protected linking cluster with a modifying metal to obtain a metallated linking moiety, deprotecting the linking cluster, and then reacting the deprotected metallated linking moiety with a framework metal.

The organo-metallic frameworks of the disclosure are useful for gas separation and catalysis. Accordingly, the disclosure provides gas sorption materials and devices comprising an organo-metallic framework of the disclosure as well as catalytic compositions and devices.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1A-C show structures of IRMOF-76 and -77. (a) Single crystal structure of IRMOF-76 (Zn₄O(C₂₃H₁₅N₂O₄)₃(X)₃ (X=BF₄, PF₆, OH)). (b) Single crystal structure of IRMOF-77 (Zn₄O(C₂₈H₂₁I₂N₃O₄Pd)₃) shown with only one pcu net. Atom colors: tetrahedron: Zn, I, Pd, O, sphere: N. The spheres represent the largest spheres that would occupy the cavity without contacting the interior van der Waals surface for IRMOF-76 and the single framework of IRMOF-77 (ca. 19 Å and 15 Å, respectively). All hydrogen atoms, counter-anions (X), and guest molecules have been omitted for clarity. (c) Space-filling illustration of IRMOF-77. Two interwoven pcu nets are shown with blue and gold colors, respectively.

FIG. 2 shows N₂ isotherm measurements for IRMOF-77 measured at 77K.

FIG. 3 shows PXRD patterns of as-synthesized IRMOF-77 (middle), quinoline-exchanged IRMOF-77 (bottom), and simulated PXRD pattern from single crystal X-ray structure (top).

FIG. 4 is an ORTEP drawing of the asymmetric unit of the IRMOF-76. All ellipsoids are displayed at the 10% probability level except for hydrogen atoms.

FIG. 5 is an ORTEP drawing of the IRMOF-77, with a half of Zn₄O unit and one link. All ellipsoids are displayed at the 30% probability level except for hydrogen atoms.

FIG. 6 shows PXRD patterns of as-synthesized IRMOF-76 (black) and simulated IRMOF-15, 16 (blue and red, respectively) from single crystal X-ray structures.

FIG. 7 is a TGA trace of as-synthesized IRMOF-76. The huge weight loss up to 150° C. corresponds to the loss of guest solvents (DMF, H₂O). A significant weight loss from 300 to 400° C. indicates the decomposition of the material.

FIG. 8 is a TGA trace of as-synthesized IRMOF-77. The huge weight loss up to 150° C. corresponds to the loss of guest solvents (DEF, pyridine, and H₂O). Presumably the material loses coordinated molecules (pyridines) up to 250° C., and a significant weight loss from 300 to 400° C. indicates the decomposition of the material.

FIG. 9 is a TGA trace of activated IRMOF-77. The weight loss around 180° C. is attributed to the partial loss of coordinated pyridine (calcd. 8.6% for full loss).

FIG. 10 is a TGA trace of organometallic linker L1. The weight loss (9.7%) up to 250° C. is in accordance with the loss of pyridine (calcd. 9.3%) to form dimer S4.

### DETAILED DESCRIPTION

As used herein and in the appended claims, the singular forms “a,” “and,” and “the” include plural referents unless the context clearly dictates otherwise. Thus, for example, reference to “a framework” includes a plurality of such frameworks and reference to “the metal” includes reference to one or more metals and equivalents thereof known to those skilled in the art, and so forth.

Unless defined otherwise, all technical and scientific terms used herein have the same meaning as commonly understood to one of ordinary skill in the art to which this disclosure belongs. Although any methods and reagents similar or equivalent to those described herein can be used in the practice of the disclosed methods and compositions, the exemplary methods and materials are now described.

Also, the use of “or” means “and/or” unless stated otherwise. Similarly, “comprise,” “comprises,” “comprising” “include,” “includes,” and “including” are interchangeable and not intended to be limiting.

It is to be further understood that where descriptions of various embodiments use the term “comprising,” those skilled in the art would understand that in some specific instances, an embodiment can be alternatively described using language “consisting essentially of” or “consisting of.”

All publications mentioned herein are incorporated herein by reference in full for the purpose of describing and disclosing the methodologies, which are described in the publications, which might be used in connection with the description herein. However, with respect to any similar or identical terms found in both the incorporated publications or references and those expressly put forth or defined in this application, then those terms definitions or meanings expressly put forth in this application shall control in all respects. The publications discussed above and throughout the text are provided solely for their disclosure prior to the filing date of the present application. Nothing herein is to be construed as an admission that the inventors are not entitled to antedate such disclosure by virtue of prior disclosure.

Metal-organic frameworks (MOFs) have been synthesized in the art, however, these prior MOFs lack chemical stability or suffer from low porosity and restricted cages/channels, which limit their use in industry.

Precise control of functionality in metal complexes is commonly achieved in molecular coordination chemistry. Developing the analogous chemistry within extended crystalline structures remains a challenge because of their tendency to lose order and connectivity when subjected to chemical reactions. Metal-organic frameworks (MOFs) are ideal candidates for performing coordination chemistry in extended structures because of their highly ordered nature and the flexibility with which the organic links can be modified. This is exemplified by the successful application of the isoreticular principle, where the functionality and metrics of an extended porous structure can be altered without changing its underlying topology.

The disclosure provides organo-metallic frameworks and methods of generating stable organo-metallic frameworks comprising MOFs, ZIFs, or COFs using a sequence of chemical reactions. One advantage of the frameworks of the disclosure is that the desired metal centers and organic links can be easily incorporated so that the porosity, functionality and channel environment can be readily adjusted and tuned for targeted functions and application.

The disclosure provides a method for generating organo-metallic frameworks. In this embodiment, covalently linked organometallic complexes within the pores of MOFs are generated. The method metalates a reactive carbene on a linking ligand, followed by deprotecting the linking clusters and reacting the metalated linking ligand with a metal. For example, a carbene (NHC) 5 precursor is metalated (L1, Scheme 1) and then assembled into the desired metalated MOF structure (e.g., IRMOF-77, Scheme 1). Also demonstrated by the disclosure is that these metalated MOFs can be further modified to increase the functionality (size, charge etc.) of the pores of the framework.

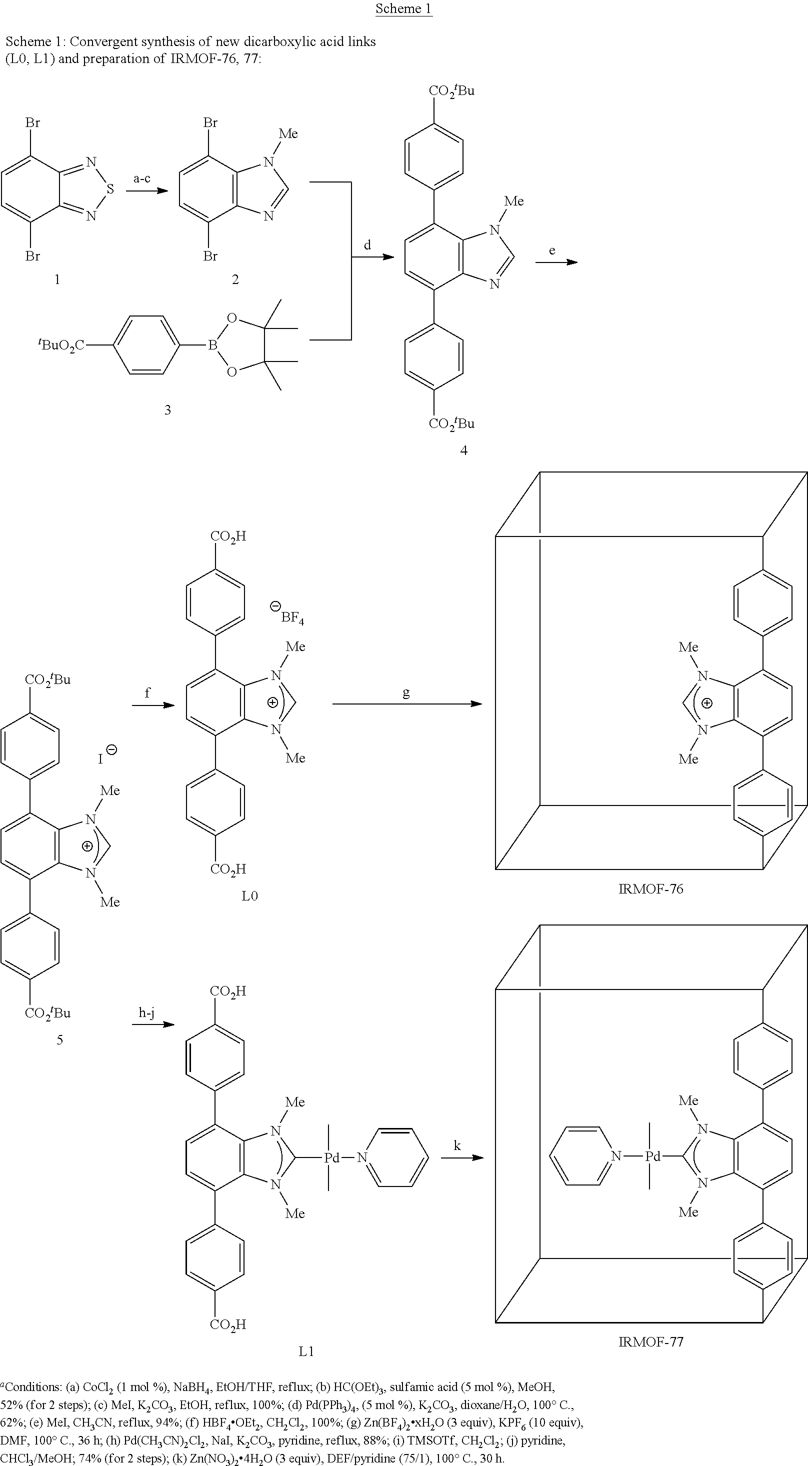

In one embodiment, the methods of the disclosure utilize process depicted in Scheme 2 to produce an organo-metallic MOF.

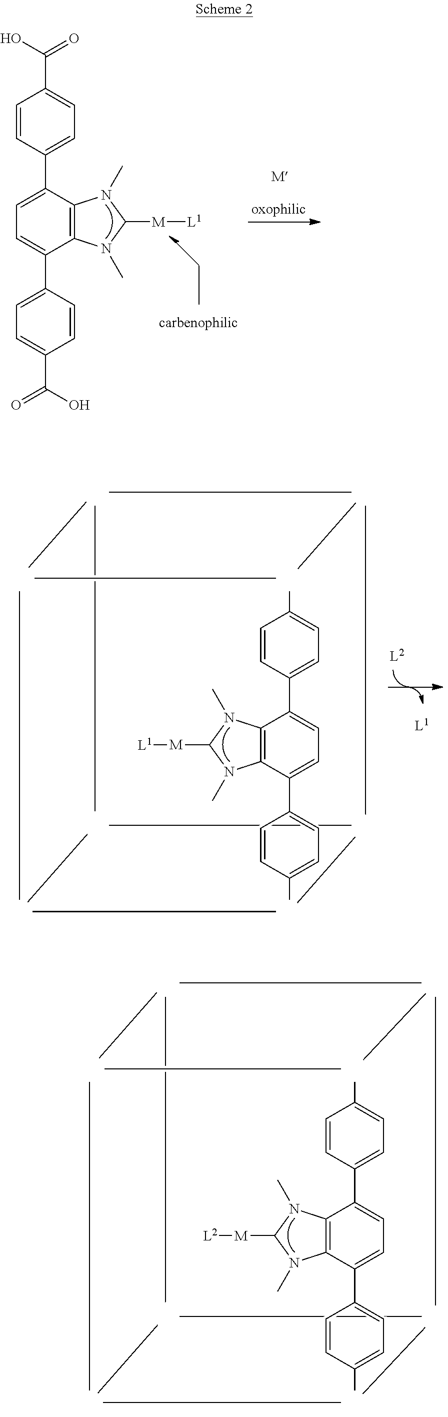

The term “cluster” refers to identifiable associations of 2 or more atoms. Such associations are typically established by some type of bond—ionic, covalent, Van der Waal, and the like.

A “linking cluster” refers to one or more reactive species capable of condensation comprising an atom capable of forming a bond between a linking moiety substructure and a metal group or between a linking moiety and another linking moiety. Examples of such reactive species include, but are not limited to, boron, sulfur, oxygen, carbon, nitrogen, and phosphorous atoms. For example, a linking cluster can comprise CO₂H, CS₂H, NO₂, SO₃H, Si(OH)₃, Ge(OH)₃, Sn(OH)₃, Si(SH)₄, Ge(SH)₄, Sn(SH)₄, PO₃H, AsO₃H, AsO₄H, P(SH)₃, AS (SH)₃, CH(RSH)₂, C(RSH)₃, CH(RNH₂)₂, C(RNH₂)₃, CH(ROH)₂, C(ROH)₃, CH(RCN)₂, C(RCN)₃, CH(SH)₂, C(SH)₃, CH(NH₂)₂, C(NH₂)₃, CH(OH)₂, C(OH)₃, CH(CN)₂, and C(CN)₃, wherein R is an alkyl group having from 1 to 5 carbon atoms, or an aryl group comprising 1 to 2 phenyl rings and CH(SH)₂, C(SH)₃, CH(NH₂)₂, C(NH₂)₃, CH(OH)₂, C(OH)₃, CH(CN)₂, and C(CN)₃. Typically ligands for MOFs contain carboxylic acid functional groups. The disclosure includes cycloalkyl or aryl substructures that comprise 1 to 5 rings that consist either of all carbon or a mixture of carbon, with nitrogen, oxygen, sulfur, boron, phosphorous, silicon and/or aluminum atoms making up the ring.

A “linking moiety” refers to a mono-dentate or polydentate compound that binds a metal or a plurality of metals, respectively through a linking cluster. Generally a linking moiety comprises a substructure comprising an alkyl or cycloalkyl group, comprising 1 to 20 carbon atoms, an aryl group comprising 1 to 5 phenyl rings, or an alkyl or aryl amine comprising alkyl or cycloalkyl groups having from 1 to 20 carbon atoms or aryl groups comprising 1 to 5 phenyl rings, and in which a linking cluster (e.g., a multidentate function group) is covalently bound to the substructure. The substructure comprises a hetrocyclic carbene that can be functionalized with a carbeneophilic metal. A cycloalkyl or aryl substructure may comprise 1 to 5 rings that comprise either of all carbon or a mixture of carbon with nitrogen, oxygen, sulfur, boron, phosphorus, silicon and/or aluminum atoms making up the ring. Typically the linking moiety will comprise a substructure having one or more carboxylic acid linking clusters covalently attached.

As used herein, a line in a chemical formula with an atom on one end and nothing on the other end means that the formula refers to a chemical fragment that is bonded to another entity on the end without an atom attached. Sometimes for emphasis, a wavy line will intersect the line.

“Carbenophilic” refers to those metals that have been found to bind to persistent carbenes. Moreover, as used herein in this application, “carbenophilic” and “modifying metal” are equivalent and are used interchangeably.

Any number of linking moieties may be used that can be functionalized with an heterocyclic carbene. For example, a linking moieties useful in the methods and compositions of the disclosure will comprise a general formula I or II:

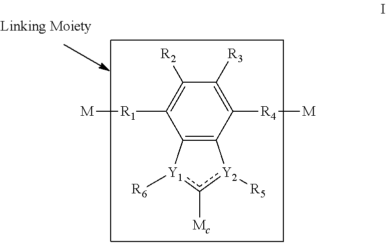

wherein Y₁ and Y₂ are independently either a nitrogen, sulfur, oxygen, phosphorous, or silicon; M is a framework metal; M_{c} is a modifying metal; R₁ and R₄ are a linking cluster, or a linking cluster that can undergo condensation with M that is connected to an alkyl, aryl, alkoxy, alkene, alkyne, phenyl and substitutions of the foregoing, sulfur-containing group (e.g., sulfide and thioalkoxy), silicon-containing group, nitrogen-containing group (e.g., amide, cyano, nitro, azide, and amino), oxygen-containing group (e.g., ketone, aldehyde, ester, ether, carboxylic acid, and acyl halide), boron-containing group, phosphorous-containing group, a tin containing group, an arsenic containing group, a germanium containing group or halogen; R₅ and R₆ are each independently selected from the group consisting of an alkyl containing 1 to 6 carbons, and H; R₂ and R₃ are selected from the group consisting of H, alkyl, aryl, alkoxy, alkenes, alkynes, phenyl and substitutions of the foregoing, sulfur-containing group (e.g., thioalkoxy), silicon-containing groups, nitrogen-containing groups (e.g., amide, amino, nitro, azide, and cyano), oxygen-containing group (e.g., ketone, aldehyde, ester, ether, carboxylic acid, and acyl halide), halogen, boron-containing group, phosphorous-containing group, carboxylic acid, NH₂, CN, OH, ═O, ═S, Cl, I, F,

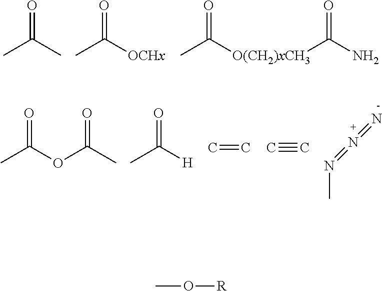

wherein X=1, 2, or 3;

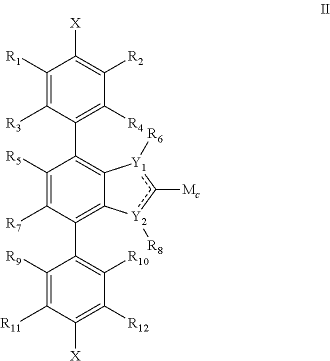

wherein Y₁ and Y₂ are independently either a nitrogen, sulfur, oxygen, phosphorous, or silicon; X is a linking cluster including, but not limited to, CO₂H, wherein R₁-R₁₂ are each independently H, alkyl, aryl, OH, alkoxy, alkene, alkyne, phenyl and substitutions of the foregoing, sulfur-containing group (e.g., thioalkoxy), silicon-containing group, nitrogen-containing groups (e.g., amide, amino, nitro, azide, and cyano), oxygen-containing groups (e.g., ketone, aldehyde, ether, ester, carboxylic acid, and acyl halide), halogen, boron-containing group, phosphorous-containing group, tin containing group, arsenic containing group, germaninum containing group, carboxylic acid, NH₂, CN, OH, ═O, ═S, Cl, I, F,

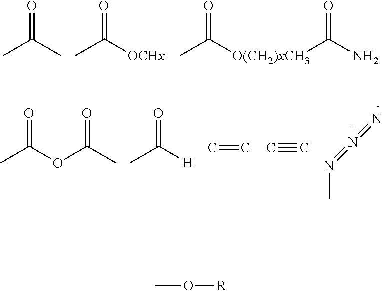

wherein X=1, 2, or 3; and M_{c} represents a modifying metal, which may further comprise a functionalizing moiety.

In yet another embodiment, the MOF comprises the general structure M-L-M, wherein M comprise a transition metal and L comprising a linking moiety having the general structure:

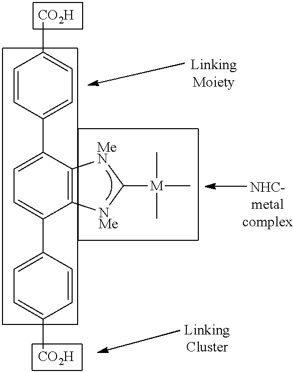

The disclosure provides a metal organic framework (MOF) derived from an heterocyclic carbene (HC) precursor compound or a preformed HC-complex of transition metals. In one embodiment, the HC-precursor comprises the general structure:

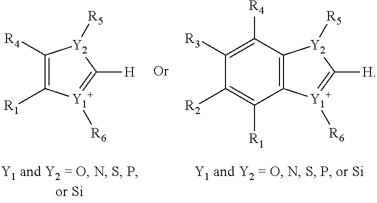

In another embodiment, the MOF comprises the general structure M-L-M, wherein M is a transition metal and wherein L is a linking moiety having a HC-precursor with a general formula:

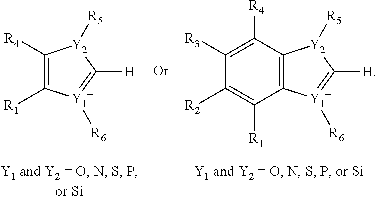

All the aforementioned organic links that possess appropriate reactive functionalities can be chemically transformed by a suitable reactant post framework synthesis to further functionalize the pores. By modifying the organic links within the framework post-synthetically, access to functional groups that were previously inaccessible or accessible only through great difficulty and/or cost is possible and facile. Post framework reactants include all known organic transformations and their respective reactants; rings of 1-20 carbons with functional groups including atoms such as N, S, O.

Examples of post framework reactants include, but are not limited to, heterocyclic compounds. In one embodiment, the post framework reactant can be a saturated or unsaturated heterocycle. The term “heterocycle” used alone or as a suffix or prefix, refers to a ring-containing structure or molecule having one or more multivalent heteroatoms as part of the ring structure and including at least 3 and up to about 20 atoms in the ring(s).

Heterocycles may be saturated or unsaturated, containing one or more double bonds, and heterocycle may contain more than one ring. When a heterocycle contains more than one ring, the rings may be fused or unfused. Fused rings generally refer to at least two rings share two atoms therebetween. Heterocycles may have aromatic character or may not have aromatic character. The terms “heterocyclic group”, “heterocyclic moiety”, “heterocyclic”, or “heterocyclo” used alone or as a suffix or prefix, refers to a radical derived from a heterocycle by removing one or more hydrogens therefrom. The term “heterocyclyl” used alone or as a suffix or prefix, refers a monovalent radical derived from a heterocycle by removing one hydrogen therefrom. The term “heteroaryl” used alone or as a suffix or prefix, refers to a heterocyclyl having aromatic character. Heterocycle includes, for example, monocyclic heterocycles such as: aziridine, oxirane, thiirane, azetidine, oxetane, thietane, pyrrolidine, pyrroline, imidazolidine, pyrazolidine, pyrazoline, dioxolane, sulfolane 2,3-dihydrofuran, 2,5-dihydrofuran tetrahydrofuran, thiophane, piperidine, 1,2,3,6-tetrahydro-pyridine, piperazine, morpholine, thiomorpholine, pyran, thiopyran, 2,3-dihydropyran, tetrahydropyran, 1,4-dihydropyridine, 1,4-dioxane, 1,3-dioxane, dioxane, homopiperidine, 2,3,4,7-tetrahydro-1H-azepine homopiperazine, 1,3-dioxepane, 4,7-dihydro-1,3-dioxepin, and hexamethylene oxide. In addition, heterocycle includes aromatic heterocycles (heteroaryl groups), for example, pyridine, pyrazine, pyrimidine, pyridazine, thiophene, furan, furazan, pyrrole, imidazole, triazole, oxazole, pyrazole, isothiazole, isoxazole, 1,2,3-triazole, tetrazole, 1,2,3-thiadiazole, 1,2,3-oxadiazole, 1,2,4-triazole, 1,2,4-thiadiazole, 1,2,4-oxadiazole, 1,3,4-triazole, 1,3,4-thiadiazole, and 1,3,4-oxadiazole.

Additionally, heterocycle encompass polycyclic heterocycles, for example, indole, indoline, isoindoline, quinoline, tetrahydroquinoline, isoquinoline, tetrahydroisoquinoline, 1,4-benzodioxan, coumarin, dihydrocoumarin, benzofuran, 2,3-dihydrobenzofuran, isobenzofuran, chromene, chroman, isochroman, xanthene, phenoxathiin, thianthrene, indolizine, isoindole, indazole, purine, phthalazine, naphthyridine, quinoxaline, quinazoline, cinnoline, pteridine, phenanthridine, perimidine, phenanthroline, phenazine, phenothiazine, phenoxazine, 1,2-benzisoxazole, benzothiophene, benzoxazole, benzthiazole, benzimidazole, benztriazole, thioxanthine, carbazole, carboline, acridine, pyrolizidine, and quinolizidine.

In addition to the polycyclic heterocycles described above, heterocycle includes polycyclic heterocycles wherein the ring fusion between two or more rings includes more than one bond common to both rings and more than two atoms common to both rings. Examples of such bridged heterocycles include quinuclidine, diazabicyclo[2.2.1]heptane and 7-oxabicyclo[2.2.1]heptane.

Heterocyclyl includes, for example, monocyclic heterocyclyls, such as: aziridinyl, oxiranyl, thiiranyl, azetidinyl, oxetanyl, thietanyl, pyrrolidinyl, pyrrolinyl, imidazolidinyl, pyrazolidinyl, pyrazolinyl, dioxolanyl, sulfolanyl, 2,3-dihydrofuranyl, 2,5-dihydrofuranyl, tetrahydrofuranyl, thiophanyl, piperidinyl, 1,2,3,6-tetrahydro-pyridinyl, piperazinyl, morpholinyl, thiomorpholinyl, pyranyl, thiopyranyl, 2,3-dihydropyranyl, tetrahydropyranyl, 1,4-dihydropyridinyl, 1,4-dioxanyl, 1,3-dioxanyl, dioxanyl, homopiperidinyl, 2,3,4,7-tetrahydro-1H-azepinyl, homopiperazinyl, 1,3-dioxepanyl, 4,7-dihydro-1,3-dioxepinyl, and hexamethylene oxidyl.

In addition, heterocyclyl includes aromatic heterocyclyls or heteroaryl, for example, pyridinyl, pyrazinyl, pyrimidinyl, pyridazinyl, thienyl, furyl, furazanyl, pyrrolyl, imidazolyl, thiazolyl, oxazolyl, pyrazolyl, isothiazolyl, isoxazolyl, 1,2,3-triazolyl, tetrazolyl, 1,2,3-thiadiazolyl, 1,2,3-oxadiazolyl, 1,2,4-triazolyl, 1,2,4-thiadiazolyl, 1,2,4-oxadiazolyl, 1,3,4-triazolyl, 1,3,4-thiadiazolyl, and 1,3,4 oxadiazolyl.

Additionally, heterocyclyl encompasses polycyclic heterocyclyls (including both aromatic or non-aromatic), for example, indolyl, indolinyl, isoindolinyl, quinolinyl, tetrahydroquinolinyl, isoquinolinyl, tetrahydroisoquinolinyl, 1,4-benzodioxanyl, coumarinyl, dihydrocoumarinyl, benzofuranyl, 2,3-dihydrobenzofuranyl, isobenzofuranyl, chromenyl, chromanyl, isochromanyl, xanthenyl, phenoxathiinyl, thianthrenyl, indolizinyl, isoindolyl, indazolyl, purinyl, phthalazinyl, naphthyridinyl, quinoxalinyl, quinazolinyl, cinnolinyl, pteridinyl, phenanthridinyl, perimidinyl, phenanthrolinyl, phenazinyl, phenothiazinyl, phenoxazinyl, 1,2-benzisoxazolyl, benzothiophenyl, benzoxazolyl, benzthiazolyl, benzimidazolyl, benztriazolyl, thioxanthinyl, carbazolyl, carbolinyl, acridinyl, pyrolizidinyl, and quinolizidinyl.

In addition to the polycyclic heterocyclyls described above, heterocyclyl includes polycyclic heterocyclyls wherein the ring fusion between two or more rings includes more than one bond common to both rings and more than two atoms common to both rings. Examples of such bridged heterocycles include quinuclidinyl, diazabicyclo[2.2.1]heptyl; and 7-oxabicyclo[2.2.1]heptyl.

In a specific embodiment, the post-framework reactant is used to generate a chelating group for the addition of a metal. The disclosure includes the chelation of all metals that may chelate to and add a functional group or a combination of previously existing and newly added functional groups. All reactions that result in tethering an organometallic complex to the framework for use, for example, as a heterogenous catalyst.

In addition, metal and metal containing compounds that may chelate to and add functional groups or a combination of previously existing and newly added functional groups are also useful. Reactions that result in the tethering of organometallic complexes to the framework for use as, for example, a heterogeneous catalyst can be used.

Metal ions that can be used in the synthesis of frameworks of the disclosure include Li⁺, Na⁺, Rb⁺, Mg²⁺, Ca²⁺, Sr²⁺, Ba²⁺, Sc³⁺, Ti⁴⁺, Zr⁴⁺, Ta³⁺, Cr³⁺, Mo³⁺, W³⁺, Mn³⁺, Fe³⁺, Fe²⁺, Ru³⁺, Ru²⁺, Os³⁺, Os²⁺, Co³⁺, Co²⁺, Ni²⁺, Ni⁺, Pd²⁺, Pd⁺, Pt²⁺, Pt⁺, Cu²⁺, Cu⁺, Au⁺, Zn²⁺, Al³⁺, Ga³⁺, In³⁺, Si⁴⁺, Si²⁺, Ge⁴⁺, Ge²⁺, Sn⁴⁺, Sn²⁺, Bi⁵⁺, Bi³⁺, and combinations thereof, along with corresponding metal salt counter-anions.

Metal ions can be introduced into open frameworks, MOFs, ZIFs and COFs, via complexation with the functionalized organic linkers (e.g., N-heterocyclic carbene) in framework backbones or by simple ion exchange. Therefore, any metal ions from the periodic table can be introduced.

The preparation of the frameworks of the disclosure can be carried out in either an aqueous or non-aqueous system. The solvent may be polar or non-polar as the case may be. The solvent can comprise the templating agent or the optional ligand containing a monodentate functional group. Examples of non-aqueous solvents include n-alkanes, such as pentane, hexane, benzene, toluene, xylene, chlorobenzene, nitrobenzene, cyanobenzene, aniline, naphthalene, naphthas, n-alcohols such as methanol, ethanol, n-propanol, isopropanol, acetone, 1,3,-dichloroethane, dichloromethane, methylene chloride, chloroform, carbon tetrachloride, tetrahydrofuran, dimethylformamide, dimethylsulfoxide, N-methylpyrollidone, dimethylacetamide, diethylformamide, thiophene, pyridine, ethanolamine, triethylamine, ethlenediamine, ethyl ether, acetonitrile, dimethylsulfoxide and the like. Those skilled in the art will be readily able to determine an appropriate solvent based on the starting reactants and the choice of solvent is not believed to be crucial in obtaining the materials of the disclosure.

Templating agents can be used in the methods of the disclosure. Templating agents employed in the disclosure are added to the reaction mixture for the purpose of occupying the pores in the resulting crystalline base frameworks. In some variations of the disclosure, space-filling agents, adsorbed chemical species and guest species increase the surface area of the metal-organic framework. Suitable space-filling agents include, for example, a component selected from the group including, but not limited to: (i) alkyl amines and their corresponding alkyl ammonium salts, containing linear, branched, or cyclic aliphatic groups, having from 1 to 20 carbon atoms; (ii) aryl amines and their corresponding aryl ammonium salts having from 1 to 5 phenyl rings; (iii) alkyl phosphonium salts, containing linear, branched, or cyclic aliphatic groups, having from 1 to 20 carbon atoms; (iv) aryl phosphonium salts, having from 1 to 5 phenyl rings; (v) alkyl organic acids and their corresponding salts, containing linear, branched, or cyclic aliphatic groups, having from 1 to 20 carbon atoms; (vi) aryl organic acids and their corresponding salts, having from 1 to 5 phenyl rings; (vii) aliphatic alcohols, containing linear, branched, or cyclic aliphatic groups, having from 1 to 20 carbon atoms; or (viii) aryl alcohols having from 1 to 5 phenyl rings.

Crystallization can be carried out by leaving the solution at room temperature or in isothermal oven for up to 300° C.; adding a diluted base to the solution to initiate the crystallization; diffusing a diluted base into the solution to initiate the crystallization; and/or transferring the solution to a closed vessel and heating to a predetermined temperature.

Also provided are devices for the sorptive uptake of a chemical species. The device includes a sorbent comprising a framework provided herein or obtained by the methods of the disclosure. The uptake can be reversible or non-reversible. In some aspects, the sorbent is included in discrete sorptive particles. The sorptive particles may be embedded into or fixed to a solid liquid- and/or gas-permeable three-dimensional support. In some aspects, the sorptive particles have pores for the reversible uptake or storage of liquids or gases and wherein the sorptive particles can reversibly adsorb or absorb the liquid or gas.

In some embodiments, a device provided herein comprises a storage unit for the storage of chemical species such as ammonia, carbon dioxide, carbon monoxide, hydrogen, amines, methane, oxygen, argon, nitrogen, argon, organic dyes, polycyclic organic molecules, and combinations thereof.

Also provided are methods for the sorptive uptake of a chemical species. The method includes contacting the chemical species with a sorbent that comprises a framework provided herein. The uptake of the chemical species may include storage of the chemical species. In some aspects, the chemical species is stored under conditions suitable for use as an energy source.

Also provided are methods for the sorptive uptake of a chemical species which includes contacting the chemical species with a device provided described herein.

Natural gas is an important fuel gas and it is used extensively as a basic raw material in the petrochemical and other chemical process industries. The composition of natural gas varies widely from field to field. Many natural gas reservoirs contain relatively low percentages of hydrocarbons (less than 40%, for example) and high percentages of acid gases, principally carbon dioxide, but also hydrogen sulfide, carbonyl sulfide, carbon disulfide and various mercaptans. Removal of acid gases from natural gas produced in remote locations is desirable to provide conditioned or sweet, dry natural gas either for delivery to a pipeline, natural gas liquids recovery, helium recovery, conversion to liquefied natural gas (LNG), or for subsequent nitrogen rejection. CO2 is corrosive in the presence of water, and it can form dry ice, hydrates and can cause freeze-up problems in pipelines and in cryogenic equipment often used in processing natural gas. Also, by not contributing to the heating value, CO₂ merely adds to the cost of gas transmission.

An important aspect of any natural gas treating process is economics. Natural gas is typically treated in high volumes, making even slight differences in capital and operating costs of the treating unit significant factors in the selection of process technology. Some natural gas resources are now uneconomical to produce because of processing costs. There is a continuing need for improved natural gas treating processes that have high reliability and represent simplicity of operation.

In addition, removal of carbon dioxide from the flue exhaust of power plants, currently a major source of anthropogenic carbon dioxide, is commonly accomplished by chilling and pressurizing the exhaust or by passing the fumes through a fluidized bed of aqueous amine solution, both of which are costly and inefficient. Other methods based on chemisorption of carbon dioxide on oxide surfaces or adsorption within porous silicates, carbon, and membranes have been pursued as means for carbon dioxide uptake. However, in order for an effective adsorption medium to have long term viability in carbon dioxide removal it should combine two features: (i) a periodic structure for which carbon dioxide uptake and release is fully reversible, and (ii) a flexibility with which chemical functionalization and molecular level fine-tuning can be achieved for optimized uptake capacities.

A number of processes for the recovery or removal of carbon dioxide from gas steams have been proposed and practiced on a commercial scale. The processes vary widely, but generally involve some form of solvent absorption, adsorption on a porous adsorbent, distillation, or diffusion through a semipermeable membrane.

The following examples are intended to illustrate but not limit the disclosure. While they are typical of those that might be used, other procedures known to those skilled in the art may alternatively be used.

### EXAMPLES

### Synthesis and Analytical Data for the Linkers (L0-L2) and IRMOF-76, 77

Chemicals were purchased from commercial suppliers and used as received unless otherwise noted. Dry solvents were obtained from an EMD Chemicals DrySolv® system. Thin-layer chromatography (TLC) was carried out using glass plates precoated with silica gel 60 with fluorescent indicator (Whatman LK6F). The plates were inspected by UV light (254 nm) and iodine/silica gel. Column chromatography was carried out using silica gel 60F (230-400 mesh). ¹H, ¹³C and ¹⁹F solution NMR spectra were recorded on Bruker ARX400 (400 MHz) or AV600 (600 MHz) spectrometers. The residual solvents are used as the internal standard for ¹H and ¹³C NMR. Trifluoroacetic acid (δ=−76.5 ppm) is used as the external standard for ¹⁹F NMR. The chemical shifts were listed in ppm on the δ scale and coupling constants were recorded in hertz (Hz). The following abbreviations were used to denote the multiplicities: s, singlet; d, doublet; t, triplet; q, quartet; b, broad peaks; m, multiplet or overlapping peaks.

¹³C CP/MAS solid state NMR spectra were collected on a Bruker DSX-300 spectrometer using a standard Bruker magic angle spinning (MAS) probe with 4 mm (outside diameter) zirconia rotors. Cross-polarization with MAS (CP/MAS) was used to acquire at 75.47 MHz (¹³C). The ¹H and ¹³C ninety-degree pulse widths were both 4 μs. The CP contact time was 1.5 ms. High power two-pulse phase modulation (TPPM) ¹H decoupling was applied during data acquisition. The decoupling frequency corresponded to 72 kHz. The MAS sample spinning rate was 10 kHz. Recycle delays betweens scans varied between 10 and 30 s, depending upon the compound as determined by observing no apparent loss in the signal intensity from one scan to the next. The ¹³C chemical shifts are given relative to tetramethylsilane as zero ppm calibrated using the methyne carbon signal of adamantane assigned to 29.46 ppm as a secondary reference.

FT-IR spectra were collected on a Shimazu FT-IR Spectrometer. Electrospray ionization mass spectra (ESI-MS), matrix-assisted laser desorption ionization mass spectra (MALDI-MS) and chemical ionization mass spectra with gas chromatography (CI/GC-MS) were conducted at Molecular Instrumentation Center in of the University of California, Los Angeles.

Elemental microanalyses were performed on a Thermo Flash EA1112 combustion CHNS analyzer. Inductively coupled plasma (ICP) anaylses for IRMOF-76 and 77 were performed by Intertek QTI.

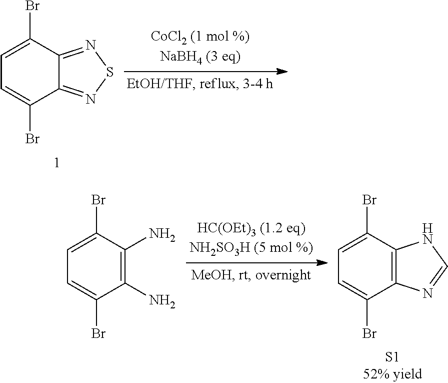 [SMILES: Brc1ccc(Br)c2nsnc12 ; Nc1c(Br)ccc(Br)c1N ; Brc1ccc(Br)c2[nH]cnc12]

S1: Starting material (1) was prepared following the reported procedure.¹ Reduction of 1 was performed following the published procedures^{1, 2} with slight modification in the work-up process. To a 2000 mL flask were added 1 (20.5 g, 70 mmol), CoCl₂ (91 mg, 0.7 mmol), THF (200 mL) and EtOH (450 mL). The mixture was heated to reflux. NaBH₄ (2.65 g, 70 mmol for each portion) was added three times (total 8.0 g) every hour. After consumption of 1 was confirmed by TLC analysis, the mixture was cooled to room temperature. After addition of water (300 mL) and vigorous stirring for 10 min, gummy precipitate was filtered off using Celite. Organic solvent was evaporated and product was extracted with dichloromethane three times. Combined organic layer was washed with water and brine and dried over Na₂SO₄. The extract was filtered off, evaporated, and the crude mixture was purified with short pad silica gel chromatography (eluent: hexane/acetone=5/1). Combined solution was evaporated to give diamine as an orange solid.

Obtained diamine was immediately used for the next step. To the diamine dissolved in MeOH (350 mL) were added HC(OEt)₃ (13.9 mL, 84 mmol) and sulfamic acid (340 mg, 3.5 mmol). The mixture was stirred overnight and powder precipitate formed. Solvent was evaporated and the residue was rinsed with ether. Drying under air gave S1 as a yellow powder (10.1 g, 52% yield for 2 steps).

¹H NMR (400 MHz, DMSO-d₆): δ=7.35 (s, 2H), 8.36 (s, 1H), 13.2 (brs, 1H); ¹³C NMR (100 MHz, DMSO-d₆): δ=113.75, 126.21, 132.75, 144.05; IR (KBr, cm⁻¹) ν=630, 792, 912, 956, 1163, 1217, 1259, 1284, 1340, 1381, 1433, 1489, 1616, 2823, 3062; CI/GC-MS [M]⁺ C₇H₄Br₂N₂⁺ m/z=276; Elemental analysis: C₇H₄Br₂N₂ Calcd. C, 30.47; H, 1.46; N, 10.15%. Found: C, 30.21; H, 1.64; N, 10.94%.

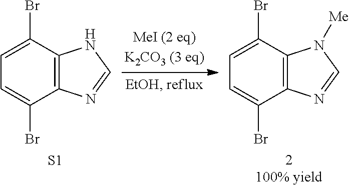

2: To a 1000 mL flask were added S1 (19.7 g, 71.4 mmol), K₂CO₃ (29.6 g, 214 mmol) and EtOH (500 mL). The mixture was heated at reflux. To the hot mixture, MeI (8.8 mL, 142.8 mmol) was added dropwise and the mixture was maintained at reflux for 1 h. After consumption of S2 was confirmed by TLC analysis, the mixture was cooled to room temperature. After addition of water (200 mL) and evaporation of EtOH, the powdered precipitate was collected, washed with water and hexane/Et₂O (1/1), and dried to give 2 as a brown powder (21.0 g, 100% yield).

¹H NMR (400 MHz, DMSO-d₆): δ=4.05 (s, 3H), 7.34 (s, 2H), 8.32 (s, 1H); ¹³C NMR (100 MHz, DMSO-d₆): δ=34.51, 102.75, 112.82, 126.14, 128.05, 132.44, 143.80, 147.96; IR (KBr, cm⁻¹) ν=524, 623, 719, 781, 918, 1058, 1105, 1186, 1219, 1273, 1301, 1332, 1390, 1465, 1500, 1604, 1816, 2940, 3086; CI/GC-MS [M]⁺ C₈H₆Br₂N₂⁺ m/z=290; Elemental analysis: C₈H₆Br₂N₂ Calcd. C, 33.14; H, 2.09; N, 9.66%. Found C, 31.92; H, 2.13; N, 9.50%.

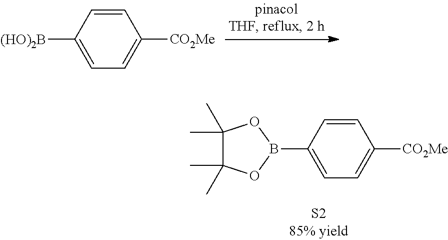 [SMILES: COC(=O)c1ccc(B(O)O)cc1 ; COC(=O)c1ccc(B2OC(C)(C)C(C)(C)O2)cc1]

S2: To a 1000 mL flask were added 4-methoxyphenylboronic acid (20.5 g, 113 mmol), pinacol (14.0 g, 118 mmol) and THF (500 mL). The mixture was heated to reflux, stirred for 2 h, and then cooled to room temperature. The solution is filtered over short pad basic aluminum oxide and the solvent was evaporated to give S2 as a white powder (26.0 g, 85% yield).

¹H NMR (400 MHz, CDCl₃): δ=1.34 (s, 12H), 3.83 (s, 3H), 7.86 (d, J=6.7 Hz, 2H), 8.01 (d, J=6.7 Hz, 2H). ¹³C NMR (100 MHz, CDCl₃): δ=24.88, 52.13, 84.16, 128.59, 132.32, 134.66, 167.12; IR (KBr, cm⁻¹) ν=486, 520, 576, 651, 709, 771, 806, 856, 1018, 1109, 1140, 1278, 1373, 1508, 1562, 1614, 1724 (s), 1950, 2985 (s); CI/GC-MS [M]⁺ C₁₄H₁₉BO₄⁺ m/z=262; Elemental analysis: C₁₄H₁₉BO₄ Calcd. C, 64.15; H, 7.31%. Found C, 64.81; H, 7.30%.

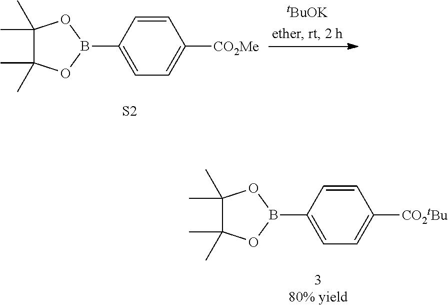

3: Transesterification was conducted following published procedure.³ To the stirred solution of S2 (13.2 g, 50 mmol) in 500 mL of anhydrous diethyl ether was added t-BuOK (28.0 g, 250 mmol) portionwise over 30 min under nitrogen atmosphere. Stirring was continued for 2 h. The suspension was poured into water (1000 mL). After the organic layer was separated, the compound was extracted with ethyl acetate three times. The combined organic layer was dried over Na₂SO₄, filtered off, and evaporated to give 3 as a white powder (12.2 g, 80% yield). 3 was used for next step without further purification.

¹H NMR (400 MHz, CDCl₃): δ=1.35 (s, 12H), 1.63 (s, 9H), 7.85 (d, J=6.7 Hz, 2H), 7.96 (d, J=6.7 Hz, 2H); ¹³C NMR (100 MHz, CDCl₃): δ=24.87, 28.19, 81.08, 84.09, 128.42, 134.25, 134.52, 165.80; IR (KBr, cm⁻¹) ν=522, 578, 651, 709, 777, 815, 854, 960, 1016, 1116, 1141, 1170, 1296, 1359, 1508, 1560, 1612, 1705 (s), 1957, 1981 (s); CI/GC-MS [M-(CH₂═C(CH₃)₂)]⁺ C₁₃H₁₈BO₄⁺ m/z=249. Elemental analysis: C₁₇H₂₅BO₄ Calcd. C, 67.12; H, 8.28%. Found C, 67.60; H, 8.23%.

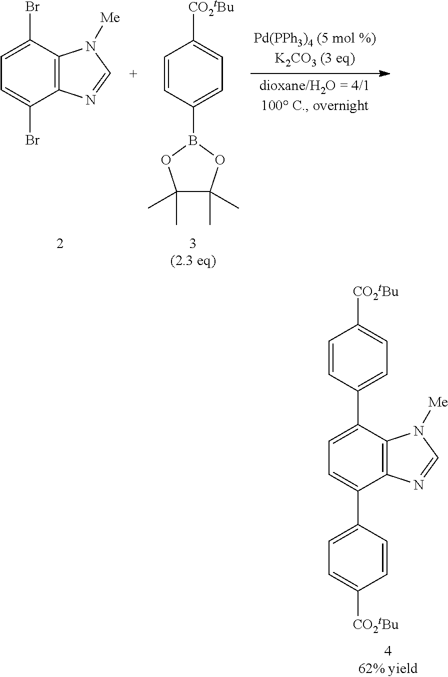

4: The stirred solution of 2 (1.93 g, 6.67 mmol), 3 (4.67 g, 15.35 mmol), Pd(PPh₃)₄ (385 mg, 0.33 mmol) and K₂CO₃ (2.76 g, 20 mmol) in 50 mL of 1,4-dioxane and 12 mL of water was heated to 100° C. under nitrogen atmosphere. Stirring was continued overnight, and then the mixture was cooled to room temperature. Water was added and organic compounds were extracted with ethyl acetate three times. The combined organic layer was washed with brine and dried over Na₂SO₄. The extract was filtered through short pad basic aluminum oxide and evaporated. The obtained residue was rinsed with hexane/Et₂O (2/1) to give 4 as a brown powder (2.0 g, 62% yield).

¹H NMR (400 MHz, CDCl₂): δ=1.62 (s, 9H), 1.64 (s, 9H), 3.42 (s, 3H), 7.23 (d, J=7.6 Hz, 1H), 7.49 (d, J=7.6 Hz, 1H), 7.52 (d, J=8.1 Hz, 2H), 7.87 (s, 1H), 8.05-8.16 (m, 6H); ¹³C NMR (100 MHz, CDCl₂): δ=28.26, 34.50, 80.79, 81.38, 121.52, 125.04, 125.99, 129.10, 129.59, 129.80, 130.79, 131.51, 131.68, 132.38, 142.32, 142.40, 145.54, 165.45, 165.87; IR (KBr, cm⁻¹) ν=509, 592, 630, 661, 704, 731, 769, 825, 848, 867, 1018, 1118, 1168, 1294, 1369, 1471, 1500, 1608, 1708 (s), 2978 (s); CI/GC-MS [M-CH₂═C(CH₃)₂]⁺ C₂₆H₂₅N₂O₄⁺ m/z=429. Elemental analysis: C₃₀H₃₂N₂O₄ Calcd. C, 74.36; H, 6.66; N, 5.78%. Found: C, 73.05; H, 6.50; N, 6.06%.

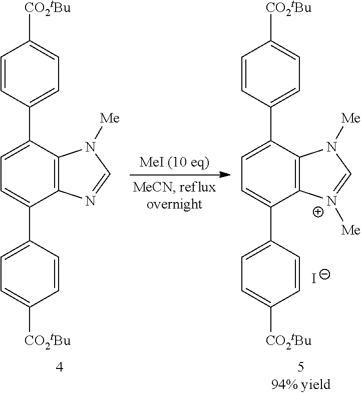 [SMILES: Cn1cnc2c(-c3ccc(C(=O)OC(C)(C)C)cc3)ccc(-c3ccc(C(=O)OC(C)(C)C)cc3)c21 ; Cn1c[n+](C)c2c(-c3ccc(C(=O)OC(C)(C)C)cc3)ccc(-c3ccc(C(=O)OC(C)(C)C)cc3)c21 ; [I-]]

5: A solution of 4 (570 mg, 1.17 mmol) and MeI (0.73 mL, 11.7 mmol) in 12 mL of acetonitrile was heated to reflux and stirred overnight. After cooling the mixture to room temperature, volatiles were evaporated. The obtained residue was rinsed with hexane/ethyl acetate (2/1) to give 5 as a brown powder (689 mg, 94% yield).

¹H NMR (400 MHz, CDCl₃): δ=1.61 (s, 18H), 3.87 (s, 6H), 7.41 (s, 2H), 7.53 (d, J=6.6 Hz, 4H), 8.10 (d, J=6.6 Hz, 4H), 10.64 (s, 1H); ¹³C NMR (100 MHz, CDCl₃): δ=28.17, 37.56, 81.79, 128.44, 128.88, 129.59, 129.77, 129.88, 132.87, 139.20, 145.38, 164.91; IR (KBr, cm⁻¹) ν=621, 709, 773, 846, 1012, 1118, 1165, 1296, 1369, 1456, 1608, 1710 (s), 2976, 3435 (br); ESI-TOF-MS [M−I]⁺ C₃₁H₃₅N₂O₄⁺ m/z=499. Elemental analysis: C₃₁H₃₅IN₂O₄ Calcd. C, 59.43; H, 5.63; N, 4.47%. Found: C, 56.83; H, 5.70; N, 4.72%.

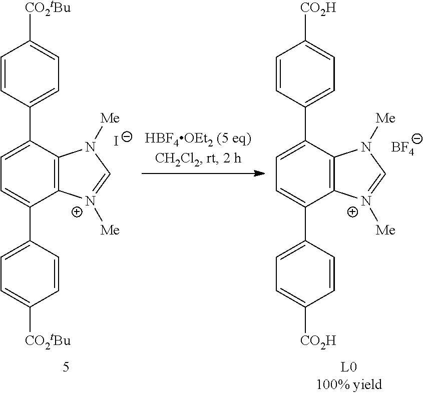

L0: To a solution of 5 (2.1 g, 3.35 mmol) in dichloromethane (35 mL) was added HBF₄.OEt₂ (2.26 mL, 16.5 mmol). The mixture was stirred for 2 h at room temperature. After dilution with diethyl ether the precipitates were filtered and washed with thoroughly with dichloromethane and diethyl ether. Toluene was added to the powder and evaporated. This is repeated twice to remove residual water as an azeotropic mixture. After drying in vacuo at 50° C., L0 was obtained as gray powder (1.7 g, 100% yield).

¹H NMR (400 MHz, DMSO-d₆): δ=3.50 (s, 6H), 7.54 (s, 2H), 7.72 (d, J=9.2 Hz, 4H), 8.03 (d, J=9.2 Hz, 4H), 9.63 (s, 1H), 13.2 (brs, 2H); ¹³C NMR (100 MHz, DMSO-d₆): δ=37.94, 128.58, 128.72, 129.72, 130.07, 130.70, 131.10, 140.12, 145.82, 163.18; ¹⁹F NMR (376.5 MHz, DMSO-d₆): δ=−148.9 (s, BF₄⁻); MALDI-MS: [M-BF₄]⁺ C₂₃H₁₉N₂O₄⁺ m/z=387.

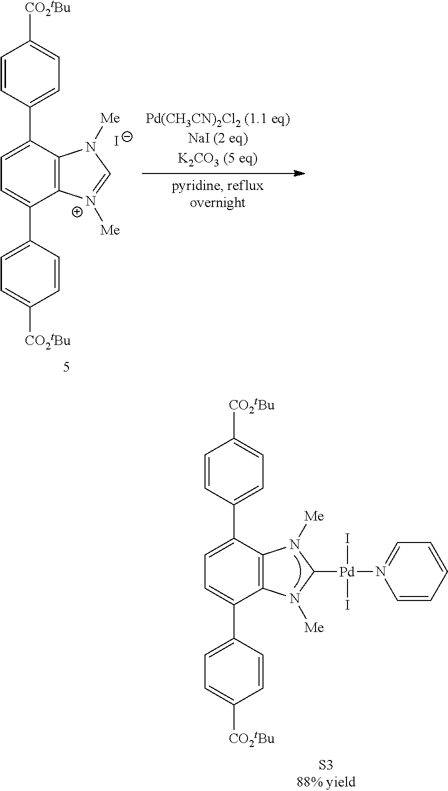

S3: A solution of 5 (1.87 g, 3 mmol), Pd(CH₃CN)₂Cl₂ (900 mg, 3.3 mmol), NaI (750 mg, 6 mmol), and K₂CO₃ (2.07 g, 15 mmol) in 30 mL of pyridine was heated to reflux and stirred overnight. After cooling the mixture to room temperature, all volatiles were evaporated. The obtained residue was dissolved in chloroform (200 mL) and water (100 mL). The separated organic layer was washed with 5% CuSO₄ aq. (30 mL, twice) and brine (30 mL), and then dried over Na₂SO₄. The extract was filtered over short pad silica gel and washed thoroughly with hexane/acetone (2/1). The combined organic solutions were evaporated to give S3 as an orange powder (2.5 g, 88% yield).

¹H NMR (400 MHz, CDCl₃): δ=1.64 (s, 18H), 3.79 (s, 6H), 7.09 (s, 2H), 7.25-7.34 (m, 2H), 7.51 (d, J=8.2 Hz, 4H), 7.70-7.77 (m, 1H), 8.11 (d, J=8.2 Hz, 4H), 8.97-9.01 (m, 2H) ¹³C NMR (100 MHz, CDCl₃): δ=28.24, 40.04, 81.53, 124.60, 125.01, 125.80, 129.27, 129.93, 132.06, 132.87, 141.45, 153.85 (NHC carbon), 165.29; IR (KBr, cm⁻¹) ν=675, 692, 769, 848, 1012, 1116, 1165, 1294, 1388, 1446, 1604, 1710 (s), 2974, 3445; Elemental analysis: C₃₆H₃₉I₂N₃O₄Pd Calcd. C, 46.10; H, 4.19; N, 4.48%. Found: C, 43.64; H, 4.02; N, 4.79%.

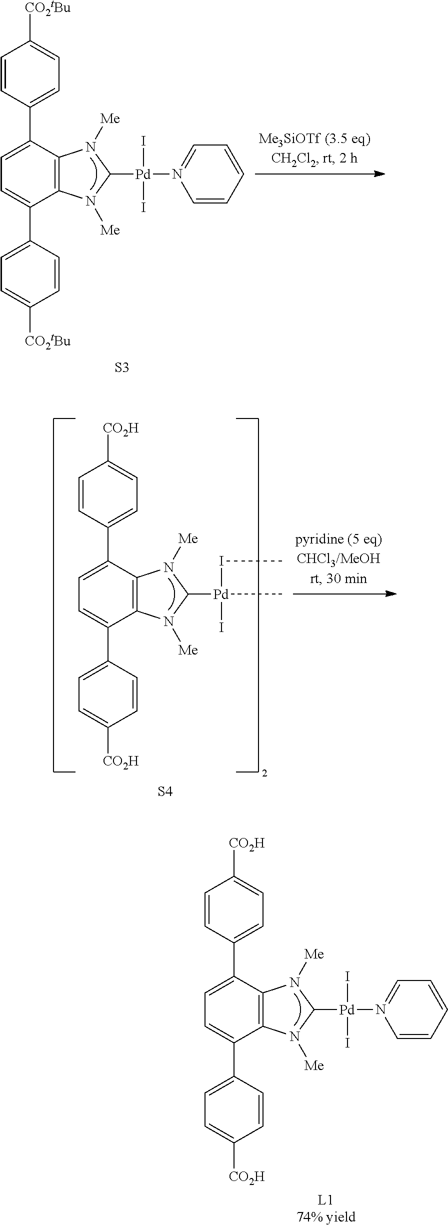

L1: To a solution of S3 (2.5 g, 2.64 mmol) in dichloromethane (15 mL) was added Me₃SiOTf (1.67 mL, 9.24 mmol). The mixture was stirred for 2 h at room temperature. After addition of water the brown precipitates were filtered and washed thoroughly with water and dichloromethane. To the brown powder (S4) in CHCl₃/MeOH (1/1, 25 mL) was added pyridine (1 mL, 13.2 mmol). The mixture was stirred for 30 min at room temperature. Volatiles were evaporated and the residue was suspended in dichloromethane. To the suspension was added 5% CuSO₄ aq. The mixture was stirred for 10 min and the orange powder was filtered and washed with water. Toluene was added to the orange powder and evaporated. This is repeated twice to remove residual water as an azeotropic mixture. After drying in vacuo, L1 was obtained as an orange powder (1.62 g, 74% yield).

¹H NMR (400 MHz, DMSO-d₆): δ=3.68 (s, 6H), 7.21 (s, 2H), 7.48-7.52 (m, 2H), 7.63 (d, J=7.6 Hz, 4H), 7.87-7.93 (m, 1H), 8.03 (d, J=7.6 Hz, 4H), 8.83-8.86 (m, 2H), 13.1 (brs, 2H); ¹³C NMR (150 MHz, 80° C., DMSO-d₆): δ=125.54, 125.72, 126.05, 130.00, 130.61, 132.67, 138.50, 141.55, 153.13 (NHC carbon), 166.57, methyl carbon peak substituted on nitrogen (˜40 ppm) was overlapped by residual peak of DMSO; ¹³C CP/MAS solid state NMR (75 M Hz): δ=42.15, 125.00, 129.27, 142.18, 153.28 (NHC carbon), 172.74; IR (KBr, cm⁻¹) ν=549, 594, 673, 692, 769, 825, 862, 920, 1012, 1078, 1109, 1176, 1290, 1386, 1444, 1606, 1685 (s), 2546, 2663, 3448; ESI-TOF-MS (anion mode) [M-pyridine-H]⁻ C₂₃H₁₇I₂N₂O₄Pd⁻ m/z=744 and isotopic patterns were well-matched to simulated ones. Elemental analysis: C₂₈H₂₃I₂N₃O₄Pd Calcd. C, 40.73; H, 2.81; N, 5.09%. Found: C, 40.22; H, 2.91; N, 5.20%.

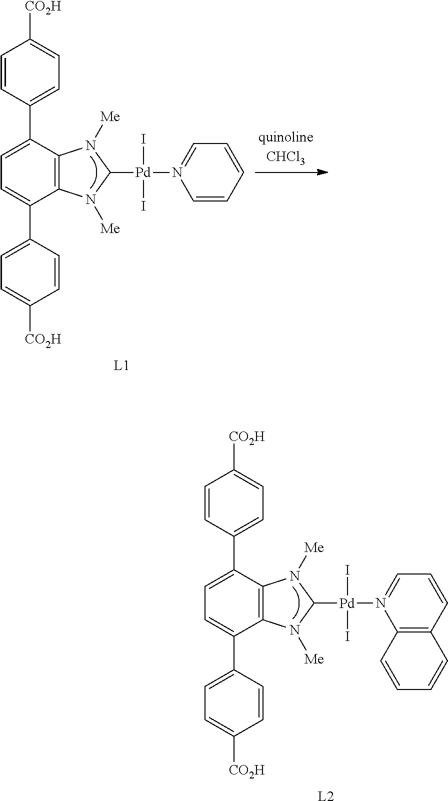

L2: To a suspension of L1 (−80 mg) in 5 mL chloroform was added quinoline (0.2 mL). The mixture was stirred for 1 h at room temperature. Volatiles were evaporated and the residue was suspended in chloroform and filtered off to collect L2 as an orange powder, which was used as a reference compound for digestion studies.

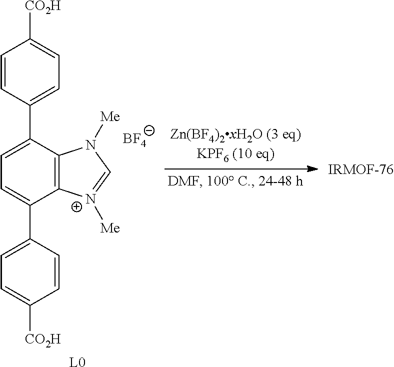

IRMOF-76: A solid mixture of L0 (47 mg, 0.1 mmol), Zn(BF₄)₂ hydrate (72 mg, 0.3 mmol), KPF₆ (186 mg, 1 mmol) was dissolved in N,N-dimethylformamide (DMF, 15 mL) in a capped vial. The reaction was heated to 100° C. for 24-48 h yielding block crystals on the wall of the vial. The vial was then removed from the oven and allowed to cool to room temperature naturally. After opening and removal of mother liquor from the mixture, colorless crystals were collected and rinsed with DMF (3×4 mL). Powder and single X-ray diffractions for this material were measured immediately. The sample dried in vacuo after solvent exchange with chloroform was used for CP/MAS NMR and IR measurements.

Analytical data for IRMOF-76: ¹⁹F NMR of digested IRMOF-76 in Dl/DMSO-d₆ (1/20). Presence of BF₄⁻ (−149.2 ppm, s) and PF₆⁻ (−71.1 ppm, d, J_{PF}=707 Hz) was confirmed.

IR (KBr, cm⁻¹) ν=557, 715, 783, 843, 1012, 1406, 1544, 1608 (s), 3421

¹³C CP/MAS solid state NMR (75 MHz) 36.10 (methyl), 129.06*, 138.69*, 143.60 (C2 of benzimidazole), 174.11 (CO₂Zn). *broadened overlapped peaks in aromatic regions.

ICP analysis. Measured elemental ratio: C₆₉H_{54.5}B_{0.53}P_{1.89}F_{10.9}N_{6.1}Zn_{4.3}. Estimated formula: Zn₄O(C₂₃H₁₇N₂O₅)₃ (BF₄)_{0.5}(PF₆)_{1.6}(OH)_{0.9}=C₆₉H_{51.9}B_{0.5}P_{1.6}F_{11.6}N₆O_{17.9}Zn₄

Neither potassium (K) nor iodine (I) were detected in more than trace amount.

Following examined postsynthetic generations of NHC from IRMOF-76 were not successful:
Treatment with Brönsted base (Potasssium/sodium/lithium tert-butoxide, DBU, Et₃N)

Treatment with Ag₂O or Ag₂CO₃

Formation of CN/CCl₃/alkoxide adduct for thermal α-elimination

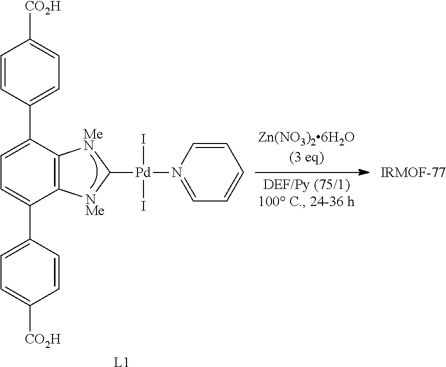

IRMOF-77: A solid mixture of L1 (16.6 mg, 0.02 mmol) and Zn(NO₂)₂.6H₂O (18 mg, 0.06 mmol) was dissolved in N,N-diethylformamide (DEF, 1.5 mL) and pyridine (0.02 mL) in a capped vial. The reaction was heated to 100° C. for 24-36 h yielding block crystals on the bottom of the vial. The vial was then removed from the oven and allowed to cool to room temperature naturally. After opening and removal of mother liquor from the mixture, light orange crystals were collected and rinsed with DEF (3×4 mL). Powder and single X-ray diffractions for this material were measured immediately.

Any impurities were separated using the difference in the crystal densities. After decanting the mother liquor, DMF and CHBr₃ (1:2 ratio) were added to crystals. Floating orange crystals were collected and used.

Activation of IRMOF-77: IRMOF-77 was activated on a Tousimis Samdri PVT-3D critical point dryer. Prior to drying, the solvated MOF samples were soaked in dry acetone, replacing the soaking solution for three days, during which the activation solvent was decanted and freshly replenished three times. Acetone-exchanged samples were placed in the chamber and acetone was completely exchanged with liquid CO₂ over a period of 2.5 h. During this time the liquid CO₂ was renewed every 30 min. After the final exchange the chamber was heated up around 40° C., which brought the chamber pressure to around 1300 psi (above the critical point of CO₂). The chamber was held under supercritical condition for 2.5 h, and CO₂ was slowly vented from the chamber over the course of 1-2 h. The dried samples were placed in a quartz adsorption tube and tested for porosity. Solid state CP/MAS NMR, IR and elemental analysis were also recorded.

Analytical Data for IRMOF-77:

### Elemental Analysis

Zn₄O(C₂₈H₂₁I₂N₃O₄Pd)₃ (H₂O)₄

Calcd.: C, 35.77; H, 2.54; I, 26.99; N, 4.47; Pd, 11.32; Zn, 9.28

Found: C, 35.04; H, 2.62; I, 26.92; N, 4.71; Pd, 9.67; Zn, 9.32.

IR (KBr, cm⁻¹)

ν=597, 673, 694, 719, 756, 783, 846, 1012, 1070, 1176, 12215, 1386 (s), 1446, 1541, 1604 (s), 3396

¹³C CP/MAS Solid State NMR (75 MHz)

IRMOF-77: 40.36 (methyl), 125.97*, 130.47*, 140.86 (pyridine), 154.10 (NHC carbon), 175.37 (CO₂Zn).

Link L1: 42.15 (methyl), 125.03*, 129.31*, 142.20 (pyridine), 153.29 (NHC carbon), 173.00 (CO₂H)

*broadened overlapped peaks in aromatic regions.

Postsynthetic Ligand Exchange of IRMOF-77: Crystals of IRMOF-77 were immersed in 4% v/v quinoline/DMF solution in a 20-mL vial, capped, and let stand for one day. The quinoline solution was decanted and the crystals were rinsed with DMF (3×4 mL) after which the PXRD pattern was immediately measured. After exchange with chloroform for one day, the solvent was evacuated overnight at room temperature. Solid state CP/MAS NMR spectra were recorded using the dried compound.

¹³C CP/MAS Solid State NMR (75 MHz) for Quinoline-Exchanged IRMOF-77:

MOF: 39.63 (methyl), 128.81*, 140.19*, 146.19 (quinoline), 152.86 (NHC carbon), 174.38 (CO₂Zn).

Link L2: 40.14 and 43.43 (non-equivalent methyl), 128.16*, 143.14*, 146.32 (quinoline), 153.59 (NHC carbon), 173.42 (CO₂H)

*broadened overlapped peaks in aromatic regions.

Single Crystal X-ray Diffraction Data Collection, Structure Solution and Refinement Procedures for IRMOF-76 and IRMOF-77. Initial scans of each specimen were performed to obtain preliminary unit cell parameters and to assess the mosaicity (breadth of spots between frames) of the crystal to select the required frame width for data collection. In every case frame widths of 0.5° were judged to be appropriate and full hemispheres of data were collected using the Bruker APEX2⁴ software suite to carry out overlapping φ and ω scans at two different detector (2θ) settings (2θ=28, 60°). Following data collection, reflections were sampled from all regions of the Ewald sphere to redetermine unit cell parameters for data integration and to check for rotational twinning using CELL_NOW. Following exhaustive review of the collected frames the resolution of the dataset was judged. Data were integrated using Bruker APEX2 V 2.1 software with a narrow frame algorithm and a 0.400 fractional lower limit of average intensity. Data were subsequently corrected for absorption by the program SADABS. The space group determinations and tests for merohedral twinning were carried out using XPREP.

All structures were solved by direct methods and refined using the SHELXTL 97 software suite. Atoms were located from iterative examination of difference F-maps following least-squares refinements of the earlier models. Final models were refined anisotropically (if the number of data permitted and stable refinement could be reached) until full convergence was achieved. Hydrogen atoms were placed in calculated positions and included as riding atoms with isotropic displacement parameters 1.2-1.5 times U_{eq} of the attached carbon atoms.

IRMOF-76: A colorless block-shaped crystal (0.60×0.60×0.40 mm) of IRMOF-76 was placed in a 1.0 mm diameter borosilicate capillary containing a small amount of mother liquor to prevent desolvation during data collection. The capillary was flame sealed and mounted on a SMART APEXII three circle diffractometer equipped with a CCD area detector and operated at 1200 W power (40 kV, 30 mA) to generate Cu Kα radiation (λ=1.5418 Å) while being cooled to 258 (2) K in a liquid N₂ cooled stream of nitrogen, and data were collected at this temperature.

Full hemispheres of data were collected using the Bruker APEX2 software suite to carry out overlapping φ and ω scans at two different detector (2θ) settings (2θ=28, 60°). A total of 96360 reflections were collected, of which 1260 were unique and 913 of these were greater than 2σ (I). The range of θ was from 1.78° to 40.06°. Analysis of the data showed negligible decay during collection. The program scale was performed to minimize differences between symmetry-related or repeatedly measured reflections.

The structure was solved in the cubic Fm 3̅m space group with Z=8. All non-hydrogen atoms except C8, C9, N1 are refined anisotropically. Others are not possible because of crystal grade and stable isotropical refinement was achieved. Atoms in the dimethylimidazolium ring (C8, C9, and N1) are found to be disordered, and they are refined as half occupancy in each component. Hydrogen atoms were placed in calculated positions and included as riding atoms with isotropic displacement parameters 1.2-1.5 times U_{eq} of the attached C atoms. The structures were examined using the Adsym subroutine of PLATON¹⁰ to assure that no additional symmetry could be applied to the models.

Modeling of electron density within the voids of the frameworks did not lead to identification of guest entities in this structure due to the disordered contents of the large pores in the frameworks. Diffuse scattering from the highly disordered solvent in the void space within the crystal and from the capillary used to set to mount the crystal contributes to the background noise and the ‘washing out’ of high angle data. Solvents were not modeled in the crystal structure. Constraints were used for the dimethylimidazolium ring (bond lengths of C7-N1, C8-N1 and C9-N1 were fixed). Considering the poor data, the structure was expected to have elevated reliability factors. Some atoms showed high Uᵢₛₒ due to low quality of the diffraction data. Poor lengths and angles are due to insufficient constraints and the esd's are also high.

The structure has been reported to display the framework of IRMOF-76 as isolated in the crystalline form. The structure is a primitive cubic framework. To prove the correctness of the atomic positions in the framework, the application of the SQUEEZE⁵ routine of A. Spek has been performed. However atomic co-ordinates for the “non-SQUEEZE” structures are also presented. No absorption correction was performed. Final full matrix least-squares refinement on F² converged to R₁=0.0549 (F>2σ (F)) and wR₂=0.2166 (all data) with GOF=0.912 For the structure where the SQUEEZE program has not been employed, final full matrix least-squares refinement on F² converged to R₁=0.1465 (F>2σ (F)) and wR₂=0.4378 (all data) with GOF=1.941. For this structure the elevated R-values are commonly encountered in MOF crystallography, for the reasons expressed above, by us and other research groups.

IRMOF-77: A light orange block-shaped crystal (0.30×0.30×0.20 mm) of IRMOF-77 was placed in a 0.4 mm diameter borosilicate capillary containing a small amount of mother liquor to prevent desolvation during data collection. The capillary was flame sealed and mounted on a SMART APEXII three circle diffractometer equipped with a CCD area detector and operated at 1200 W power (40 kV, 30 mA) to generate Cu Kα radiation (λ=1.5418 Å) while being cooled to 258 (2) K in a liquid N₂ cooled stream of nitrogen, and data were collected at this temperature.

Full hemispheres of data were collected using the Bruker APEX2 software suite to carry out overlapping φ and ω scans at two different detector (2θ) settings (2θ=28, 60°). A total of 51319 reflections were collected, of which 3946 were unique and 2238 of these were greater than 2σ (I). The range of θ was from 2.06° to 39.74°. Analysis of the data showed negligible decay during collection. The program scale was performed to minimize differences between symmetry-related or repeatedly measured reflections.

The structure was solved by direct method and refined using the SHELXTL 97 software suite. Atoms were located from iterative examination of difference F-maps following least squares refinements of the earlier models. The structure was solved in the trigonal R 3̅c space group with Z=12. All zinc atoms (Zn1, Zn2), palladium atom (Pd1), iodine atoms (I1, I2) and other non-hydrogen atoms on backbones of the framework (except for C6, C12, C17) are refined anisotropically with hydrogen atoms generated as spheres riding the coordinates of their parent atoms. Others are not possible because of crystal grade and stable isotropical refinement was achieved. Hydrogen atoms were placed in calculated positions and included as riding atoms with isotropic displacement parameters 1.2-1.5 times U_{eq} of the attached C atoms. The structures were examined using the Adsym subroutine of PLATON to assure that no additional symmetry could be applied to the models.

Modeling of electron density within the voids of the frameworks did not lead to identification of guest entities in this structure due to the disordered contents of the large pores in the frameworks. High esd's make it impossible to determine accurate positions for solvent molecules. Thus, first several unidentified peaks within void spaces which could not be assigned to any definite entity were modeled as isolated oxygen atoms.

The structure has been reported to display the framework of IRMOF-77 as isolated in the crystalline form. The structure is a two-fold interpenetrating cubic framework. To prove the correctness of the atomic positions in the framework, the application of the SQUEEZE routine of A. Spek has been performed. However atomic co-ordinates for the “non-SQUEEZE” structures are also presented. Thus the structure reported after SQUEEZE does not include any solvents. No absorption correction was performed. Final full matrix least-squares refinement on F² converged to R₁=0.0560 (F>2σ(F)) and wR₂=0.1389 (all data) with GOF=0.950 For the structure where the SQUEEZE program has not been employed, final full matrix least-squares refinement on F² converged to R₁=0.1039 (F>2σ(F)) and wR₂=0.3399 (all data) with GOF=1.141. A final ratio of 12.0 for reflections to parameters was achieved. For this structure the elevated R-values are commonly encountered in MOF crystallography, for the reasons expressed above, by us and other research groups.

TABLE 1
Crystal data and structure refinement for IRMOF-76

| Empirical formula | C₆₉ H₄₅ N₆ O₁₃ Zn₄ | |
|---|---|---|
| Formula weight | 1427.59 | |
| Temperature | 258(2) K | |
| Wavelength | 1.54178 Å | |
| Crystal system | Cubic | |
| Space group | Fm 3̅m | |
| Unit cell dimensions | a = 42.9245(2) Å | α = 90.00° |
| | b = 42.9245(2) Å | β = 90.00° |
| | c = 42.9245(2) Å | γ = 90.00° |

| | |
|---|---|
| Volume | 79088.9(6) |
| Z | 8 |
| Density (calculated) | 0.240 Mg/m³ |
| Absorption coefficient | 0.368 mm⁻¹ |
| F(000) | 5800 |
| Crystal size | 0.60 × 0.60 × 0.40 mm³ |
| Theta range for data | 1.78-40.06° |
| collection | |
| Index ranges | −35 <= h <= 35, −34 <= k <= 35, −34 <= |
| | l <= 31 |
| Reflections collected | 96360 |
| Independent reflections | 1260 [R(int) = 0.0707] |
| Completeness to theta = | 40.06° 99.7% |
| Absorption correction | None |
| Refinement method | Full-matrix least-squares on F² |
| Data/restraints/parameters | 1260/3/56 |
| Goodness-of-fit on F² | 1.941 |
| Final R indices | R₁ = 0.1465, wR₂ = 0.4135 |
| [I > 2sigma(I)] | |
| R indices (all data) | R₁ = 0.1669, wR₂ = 0.4378 |
| Largest diff. peak and hole | 0.450 and −0.278 e.Å⁻³ |

TABLE 2
Crystal data and structure refinement for IRMOF-76 (SQUEEZE).

| Empirical formula | C₆₉ H₄₅ N₆ O₁₃ Zn₄ | |
|---|---|---|
| Formula weight | 1427.59 | |
| Temperature | 258(2) K | |
| Wavelength | 1.54178 Å | |
| Crystal system | Cubic | |
| Space group | Fm 3̅m | |
| Unit cell dimensions | a = 42.9245(2) Å | α = 90.00° |
| | b = 42.9245(2) Å | β = 90.00° |
| | c = 42.9245(2) Å | γ = 90.00° |

| | |
|---|---|
| Volume | 79088.9(6) |
| Z | 8 |
| Density (calculated) | 0.240 Mg/m³ |
| Absorption coefficient | 0.368 mm⁻¹ |
| F(000) | 5800 |
| Crystal size | 0.60 × 0.60 × 0.40 mm³ |
| Theta range for data | 1.78-40.06° |
| collection | |
| Index ranges | −35 <= h <= 35, −34 <= k <= 35, −34 <= |
| | l <= 31 |
| Reflections collected | 96360 |
| Independent reflections | 1260 [R(int) = 0.0597] |
| Completeness to theta = | 40.06° 99.7% |
| Absorption correction | None |
| Refinement method | Full-matrix least-squares on F² |
| Data/restraints/parameters | 1260/3/56 |
| Goodness-of-fit on F² | 0.912 |
| Final R indices | R₁ = 0.0549, wR₂ = 0.1954 |
| [I > 2sigma(I)] | |
| R indices (all data) | R₁ = 0.0698, wR₂ = 0.2166 |
| Largest diff. peak and hole | 0.120 and −0.316 e.Å⁻³ |

TABLE 3
Crystal data and structure refinement for IRMOF-77

| Empirical formula | C₈₄ H₆₃ I₆ N₉ O₁₄ Pd₃ Zn₄, 16(O) | |
|---|---|---|
| Formula weight | 3020.51 | |
| Temperature | 258(2) K | |
| Wavelength | 1.54178 Å | |
| Crystal system | Trigonal | |
| Space group | R 3̅c | |
| Unit cell dimensions | a = 31.0845(4) Å | α = 90.00° |
| | b = 31.0845(4) Å | β = 90.00° |
| | c = 71.018(2) Å | γ = 120.00° |

| | |
|---|---|
| Volume | 59427(2) |
| Z | 12 |
| Density (calculated) | 1.013 Mg/m³ |
| Absorption coefficient | 10.364 mm⁻¹ |
| F(000) | 17352 |
| Crystal size | 0.30 × 0.30 × 0.20 mm³ |
| Theta range for data | 2.06-39.74° |
| collection | |
| Index ranges | −25 <= h <= 24, −25 <= k <= 25, −55 <= |
| | l <= 58 |
| Reflections collected | 51319 |
| Independent reflections | 3946 [R(int) = 0.1843] |
| Completeness to theta = | 39.74° 99.8% |
| Absorption correction | None |
| Refinement method | Full-matrix least-squares on F² |
| Data/restraints/parameters | 3946/0/327 |
| Goodness-of-fit on F² | 1.141 |
| Final R indices | R₁ = 0.1033, wR₂ = 0.2897 |
| [I > 2sigma(I)] | |
| R indices (all data) | R₁ = 0.1754, wR₂ = 0.3399 |
| Largest diff. peak and hole | 0.987 and −0.706 e.Å⁻³ |

TABLE 4
Crystal data and structure refinement for IRMOF-77 (SQUEEZE)

| Empirical formula | C₈₄ H₆₃ I₆ N₉ O₁₃ Pd₃ Zn₄ | |
|---|---|---|
| Formula weight | 2748.51 | |
| Temperature | 258(2) K | |
| Wavelength | 1.54178 Å | |
| Crystal system | Trigonal | |
| Space group | R 3̅c | |
| Unit cell dimensions | a = 31.0845(4) Å | α = 90.00° |
| | b = 31.0845(4) Å | β = 90.00° |
| | c = 71.018(2) Å | γ = 120.00° |

| | |
|---|---|
| Volume | 59427(2) |
| Z | 12 |
| Density (calculated) | 0.922 Mg/m³ |
| Absorption coefficient | 10.259 mm⁻¹ |
| F(000) | 15720 |
| Crystal size | 0.30 × 0.30 × 0.20 mm³ |
| Theta range for data | 2.06-39.74° |
| collection | |
| Index ranges | −25 <= h <= 24, −25 <= k <= 25, −55 <= |
| | l <= 58 |
| Reflections collected | 51319 |
| Independent reflections | 3946 [R(int) = 0.1455] |
| Completeness to theta = | 39.74° 99.8% |
| Absorption correction | None |
| Refinement method | Full-matrix least-squares on F² |
| Data/restraints/parameters | 3946/0/333 |
| Goodness-of-fit on F² | 0.950 |
| Final R indices | R₁ = 0.0560, wR₂ = 0.1239 |
| [I > 2σ(I)] | |
| R indices (all data) | R₁ = 0.1070, wR₂ = 0.1389 |
| Largest diff. peak and hole | 0.958 and −0.350 e.Å⁻³ |

The successful isoreticular covalent transformation followed by metalation as demonstrated herein opens a route for incorporating metal ions into a wide range of frameworks. Fundamentally, it expands the reaction space that can be carried out within MOFs.

Synthetic procedure for Zr-aminoterephalate MOF: 40 mg (ZrCl₄) with 2-aminoterephalic acid 100 mg was placed in a glass vial with 40 ml of DMF. The reaction was heated at 85° C. for three days. The powder was filtered exchanged in chloroform 3×40 ml.

Experimental and Simulated Powder X-Ray Diffraction Patterns. Powder X-ray diffraction (PXRD) data were collected using a Bruker D8-Discover θ-2θ diffractometer in reflectance Bragg-Brentano geometry. Cu Kα₁ radiation (λ=1.5406 Å; 1600 W, 40 kV, 40 mA) was focused using a planar Gobel Mirror riding the Kα line. A 0.6 mm divergence slit was used for all measurements. Diffracted radiation was detected using a Vantec line detector (Bruker AXS, 6° 2θ sampling width) equipped with a Ni monochromator. All samples were mounted on a glass slide fixed on a sample holder by dropping crystals and then leveling the sample surface with a wide blade spatula. The best counting statistics were achieved by using a 0.02° 2θ step scan from 2-50° with an exposure time of 0.4 s per step.

Thermal Gravimetric Analysis (TGA) Data for IRMOF-76, 77. All samples were run on a TA Instruments Q-500 series thermal gravimetric analyzer with samples held in platinum pan in a continuous flow nitrogen atmosphere. Samples were heated at a constant rate of 5° C./min during all TGA experiments.

Porosity Measurements for IRMOF-77. Low pressure gas adsorption isotherms were measured volumetrically on an Autosorb-1 analyzer (Quantachrome Instruments). A liquid N₂ bath (77K) was used for N₂ isotherm measurements. The N₂ and He gases used were UHP grade (99.999%). For the calculation of surface areas, the Langmuir and BET methods were applied using the adsorption branches of the N₂ isotherms assuming a N₂ cross-sectional area of 16.2 Å²/molecule. The Langmuir and BET surface areas are estimated to be 1610 and 1590 m² g⁻¹, respectively. The pore volume was determined using the Dubinin-Raduskavich (DR) method with the assumption that the adsorbate is in the liquid state and the adsorption involves a pore-filling process. Given the bulk density of IRMOF-77 (0.922 g cm⁻³), calculated pore volume (0.57 cm³ g⁻¹) corresponds to 0.53 cm³ cm⁻³.

This example targeted a structure based on the well-known primitive cubic MOF-5 and utilized a linear ditopic carboxylate link that could accommodate an NHC-metal complex or its precursor. The disclosure demonstrates a convergent synthetic route for new links utilizing cross-coupling reactions as the key step to combine the imidazolium core with the carboxylate modules (Scheme 2, above).

The synthesis of 4,7-bis(4-carboxylphenyl)-1,3-dimethylbenzimidazium tetrafluoroborate (L0) starts from the known 4,7-dibromobenzthiaziazole (1). Cobalt-catalyzed reduction with sodium borohydride followed by acid-catalyzed condensation with triethylorthoformate converted thiaziazole to benzimidazole. Successive N-methylation produced a dibromobenzimidazole core (2). Pd(0)-catalyzed Suzuki-Miyaura cross-coupling between 2 and 4-(tert-butoxycarbonyl)phenylpinacolborane (3) resulted in the diester-terminated linear terphenyl strut (4).

In particular, for the synthesis of L0, the module possessing a tert-butyl ester as a masked carboxylic acid was selected because of improved solubility and feasible late-stage unmasking of carboxylic acid. Treatment with an excess of methyl iodide produced 5, possessing the N,N′-dimethylbenzimidazolium moiety. L0 was then obtained by deprotection of two tert-butyl esters using HBF₄ concomitant with counteranion substitution from I⁻ to BF₄⁻. All conversions were feasible on a gram scale.

The synthesis of IRMOF-76 was carried out using a mixture of three equivalents of Zn(BF₄)₂.xH₂O, ten equivalents of KPF₆ and L0 in N,N-dimethylformamide (DMF). The mixture was heated at 100° C. for 36 h, whereupon colorless crystals of IRMOF-76 (Zn4O(C₂₃H₁₅N₂O₄)(X)₃ (X=BF₄, PF₆, OH)) were obtained.

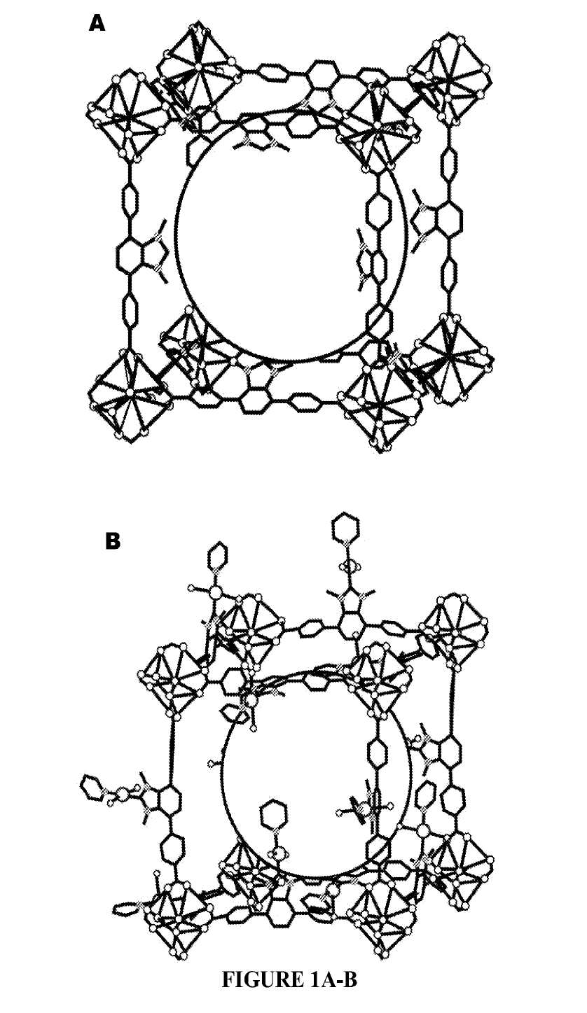

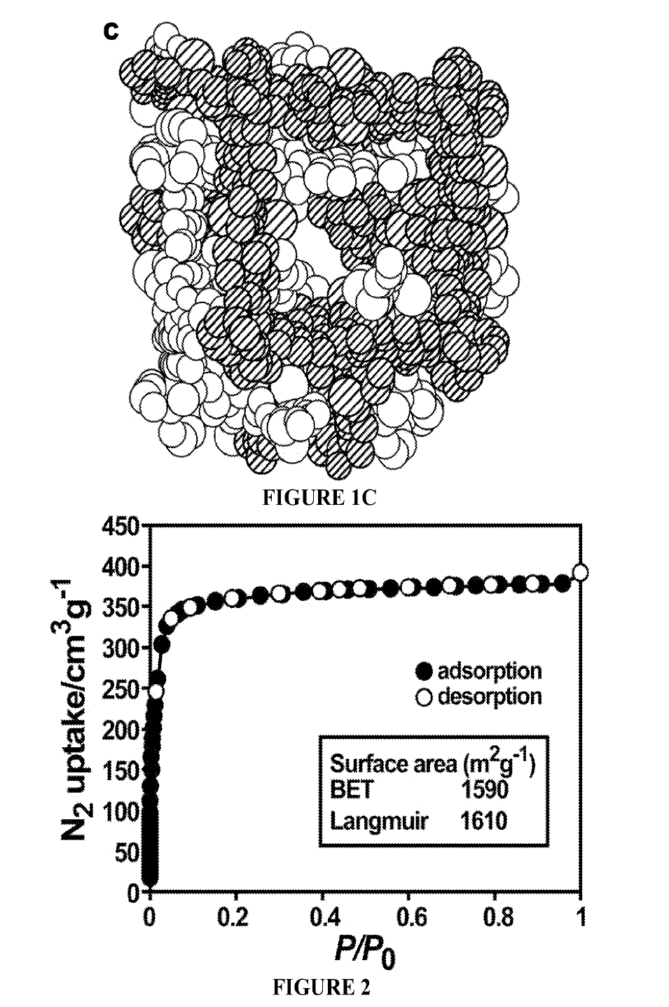

Single crystal X-ray diffraction analysis revealed that IRMOF-76 is isoreticular with MOF-5. Here, Zn₄O units are connected to six L0 links to form a cubic framework of pcu topology (FIG. 1a). IRMOF-76 is a non-interpenetrated cationic MOF possessing imidazolium moieties (NHC precursors) on each link. The ICP analysis and ¹⁹F NMR spectrum of digested IRMOF-76 reveal that both BF₄⁻ and PF₆⁻ are included as counter-anions of the imidazolium moieties.

A strategy using a link possessing a metal-NHC complex was developed. The metal-NHC bond is generally stable even under mild acidic conditions, and chemoselective NHC-coordination avoids undesired reactions with metal sources in the construction of secondary building units (SBUs), which, in many cases, relies on oxygen-metal coordination. In the specific example described herein, [4,7-bis(4-carboxylphenyl)-1,3-dimethylbenzimidazole-2-ylidene](pyridyl) palladium(II) iodide (L1, Scheme 2) was used, which is potentially attractive as a catalyst homologous to known homogeneous catalyst systems.

L1 was prepared from intermediate 5 (Scheme 2). The benzimidazolium moiety of 5 was converted to the NHC-PdI₂ (py) complex when refluxed in pyridine with a Pd(II) source, a base (K₂CO₃), and an iodide source (NaI). Deprotection of the tert-butyl esters was achieved with trimethylsilyl trifluoromethanesulfonate (TMSOTf). The covalently formed Pd(II)-NHC bond was surprisingly stable even under the strongly Lewis acidic conditions for deprotection. However, the pyridine co-ligand was removed to form dimeric complexes. Adding pyridine as a ligand was necessary to produce L1 possessing a monomeric NHC-PdI₂(py) moiety.

The synthesis of IRMOF-77 was conducted using Zn(NO₃)₂.6H₂O of three equivalents to L1 in a solvent mixture of N,N-diethylformamide (DEF) and pyridine (75/1). The mixture was heated at 100° C. for 30 h, whereupon orange crystals of IRMOF-77 (Zn₄O(C₂₈H₂₁I₂N₃O₄Pd) 3) were obtained.

X-ray single crystal structure analysis reveals that IRMOF-77 is also isoreticular with MOF-5. The X-ray crystal structure verifies the presence of the NHC-PdI₂(py) moiety (FIG. 1b). The Zn ions used for the construction of the framework are not involved in binding with the metal-NHC moiety. Measured elemental compositions in accordance with the expected values confirm the absence of undesired metal exchange on NHC. The observed Pd—C distance (1.925 Å) and coordination geometry match well with those found in the Cambridge Structural Database for NHC-PdX₂(py) (X=halide) complexes. The presence of the Pd(II)-NHC bond was further confirmed by the solid state ¹³C cross-polarization magic angle spinning (CP/MAS) NMR spectrum (δ=154.1 ppm for N—C:—N). NHC-Pd(II) moieties are positioned on every face of the cubic cage within the framework. Two interwoven frameworks were formed with ca. 7 Å offset distance (FIG. 1c), presumably to mitigate the interference of the metal-NHC moieties with each other, with 4.06 Å shortest distances between two methyl carbons from two frameworks. As a result, the catenation is different from that of IRMOF-15, whose link length is the same as L1. Due to the interwoven nature of the structure, the pore aperture is ca. 5 Å×10 Å. All immobilized Pd(II) centers protrude into the pores without blocking each other.

To confirm the presence of void space and the architectural stability of IRMOF-77, the permanent porosity was demonstrated by the N₂ adsorption isotherm of the guest-free samples. The isotherm shows steep N₂ uptake in the low-pressure region, which indicates that the material is microporous (FIG. 2). The Langmuir and BET surface areas of activated IRMOF-77 are calculated to be 1,610 and 1,590 m² g⁻¹, respectively. The amount of N₂ uptake in the pores (P/P₀=0.9) corresponds to 46 N₂ molecules per formula unit or 552 per unit cell.

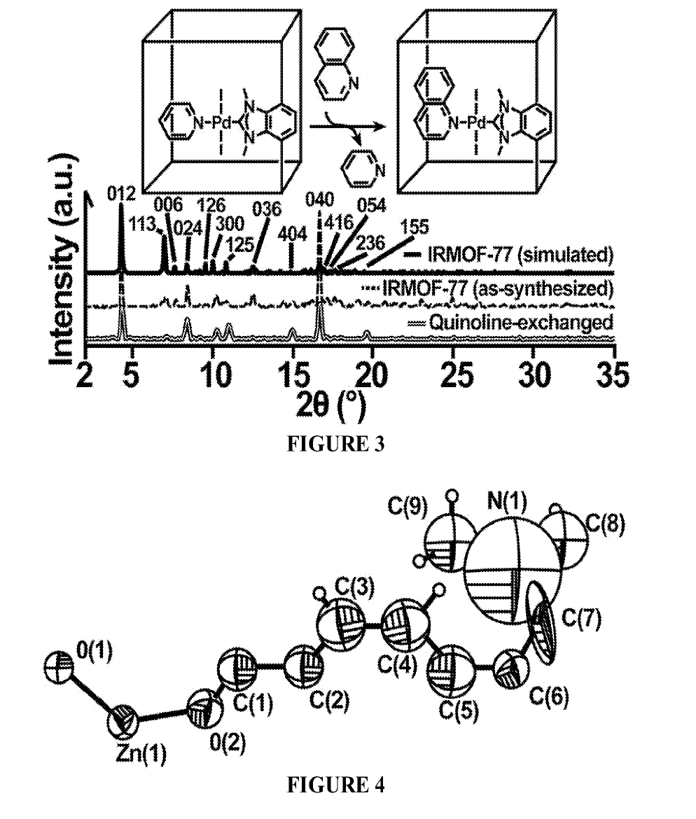

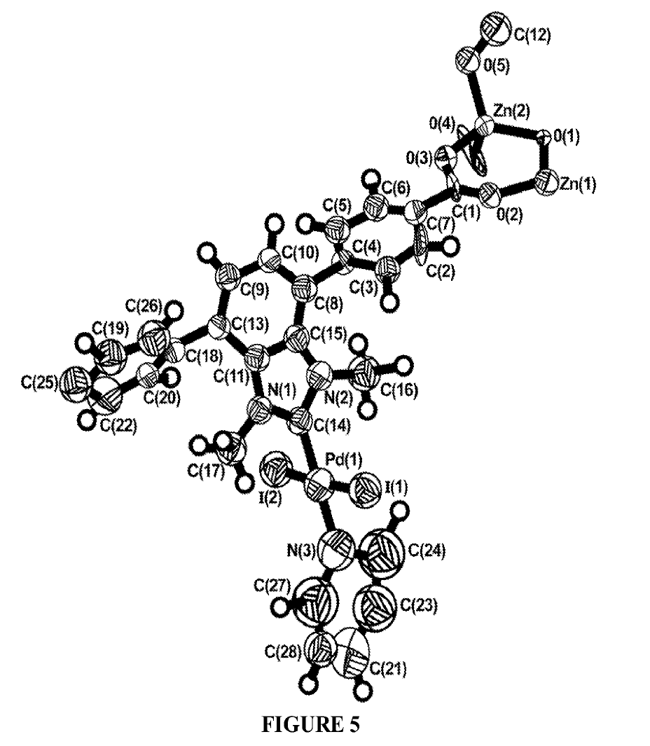

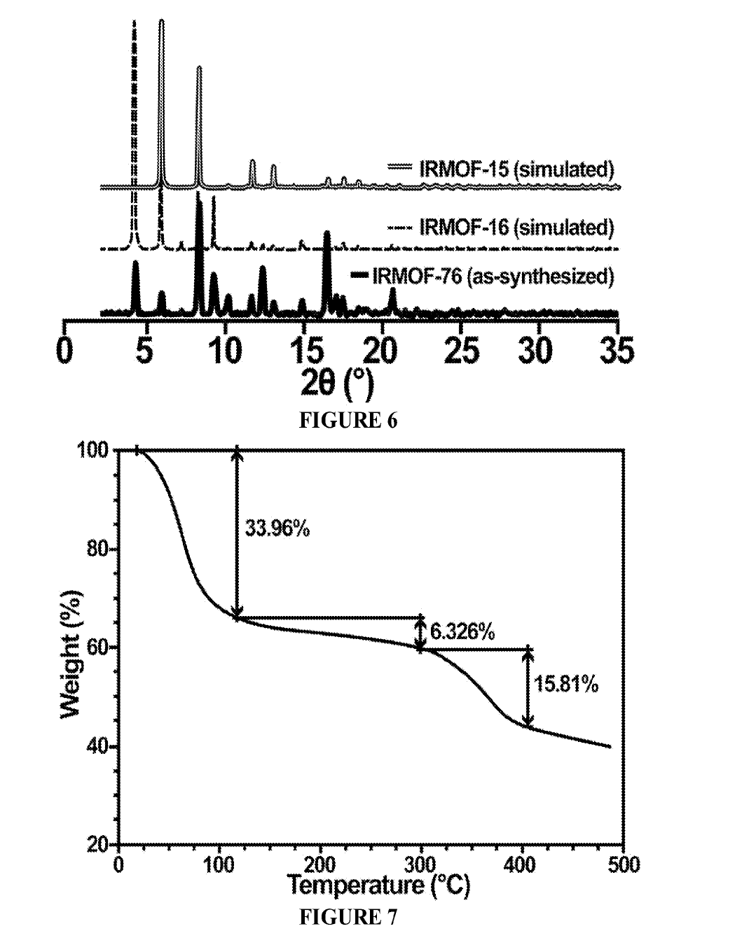

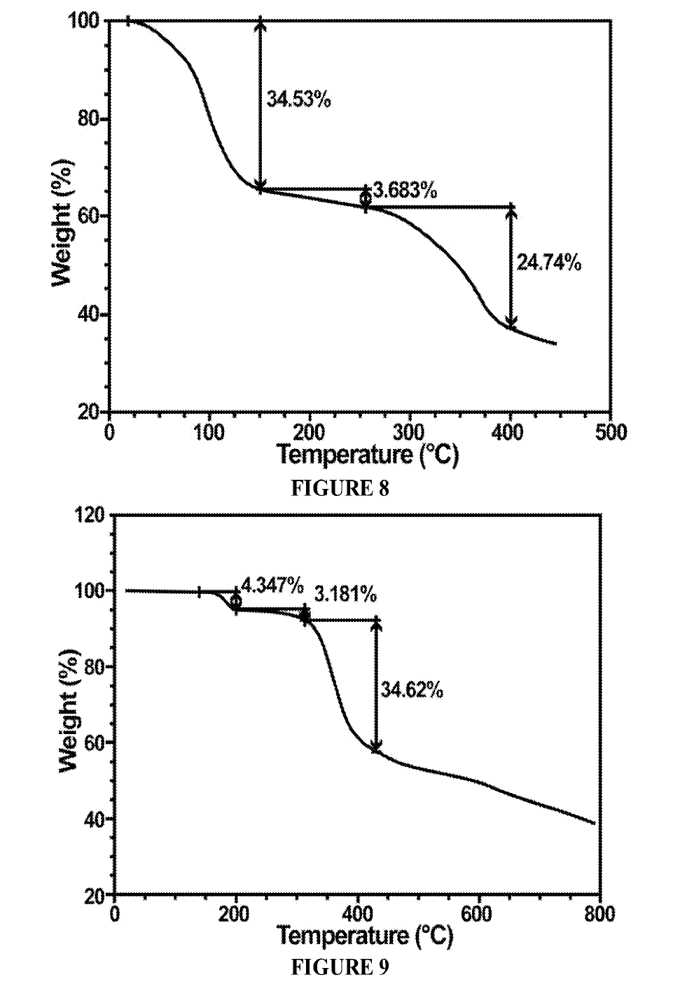

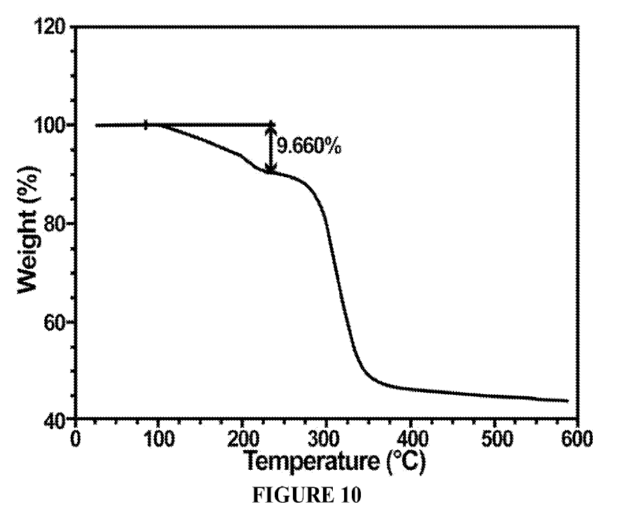

To examine the reactivity of the immobilized Pd(II) centers of IRMOF-77, ligand exchange experiments were carried out by immersing as-synthesized crystals of IRMOF-77 in 4 v/v % quinoline/DMF solution for one day at room temperature. A comparison between the powder X-ray diffraction (PXRD) patterns before and after exchange reveals that the framework remains intact during the exchange process (FIG. 3). No signal from the pyridine protons is observed in the ¹H NMR spectrum of the digested MOF after ligand exchange. Only the signals from quinoline are observed with the expected molar stoichiometry (carboxylate link:quinoline=1:1). Retention of the NHC-Pd bond is confirmed by the ¹³C CP/MAS solid state NMR spectrum (before: 154.1 ppm, after: 152.9 ppm). These results indicate the presence of NHC-PdI₂ (quinoline) complex after ligand exchange.

The structures of IRMOF-76 and 77 demonstrate the successful application of the methods of the disclosure to immobilize Pd(II)-NHC organometallic complex in MOFs without losing the MOF's porosity and its structural order.

A number of embodiments of the invention have been described. Nevertheless, it will be understood that various modifications may be made without departing from the spirit and scope of the invention. Accordingly, other embodiments are within the scope of the following claims.

1. An organo-metallic framework comprising the general structure M-L-M, wherein M is a framework metal and wherein L is a linking moiety comprising an N-heterocyclic carbene.

2. The organo-metallic framework of claim 1, wherein the linking moiety is metallated prior to reacting with the framework metal.

3. (canceled)

4. The organo-metallic framework of claim 1, wherein the framework comprises a covalent organic framework (COF), a zeolitic imidizole framework (ZIF) or a metal organic framework (MOF).

5. The organo-metallic framework of claim 1, wherein the framework metal is selected from the group consisting of Li, Na, Rb, Mg, Ca, Sr, Ba, Sc, Ti, Zr, Ta, Cr, Mo, W, Mn, Fe, Ru, Os, Co, Ni, Pd, Pt, Cu, Au, Zn, Al, Ga, In, Si, Ge, Sn, and Bi.

6. The organo-metallic framework of claim 1, wherein the linking moiety comprising the heterocyclic carbene is modified with a modifying metal.

7. The organo-metallic framework of claim 6, wherein the modifying metal is selected from the group consisting of L1, Be, Na, Mg, Al, Si, K, Ca, Ti, V, Cr, Mn, Fe, Co, Ni, Cu, Zn, Ga, Ge, Sr, Y, Zr, Nb, Mo, Ru, Rh, Pd, Ag, Sn, Te, Ba, Hf, Ta, W, Re, Os, Ir, Pt, Au, Hg, Sm, Eu, and Yb

8. The organo-metallic framework of claim 6, wherein the modifying metal extends into a pore of the framework.

9. The organo-metallic framework of claim 1, wherein the framework lacks a guest species.

10. A method of making an organo-metallic framework of claim 1 comprising reacting a linking moiety comprising a heterocyclic carbene and comprising a protected linking cluster with a modifying metal to obtain a metallated linking moiety, deprotecting the linking cluster and reacting the deprotected metallated linking moiety with a framework metal.

11. A gas sorption composition comprising an organo-metallic framework of claim 1.

12. A catalyst composition comprising an organo-metallic framework of claim 1.

13. A framework comprising repeating cores, wherein the cores are comprised of one or more organic-based links that are linked to one or more metals, metal ions, or organic-based links, through one or more linking clusters, and wherein at least one of the organic-based links has a carbene that can be metallated with a modifying metal, metal ion, or metal containing compound.

14. The framework of claim 13, wherein the framework is a ZIF or MOF, and the one or more organic-based links are one or more linking moieties comprising optionally substituted aryls, optionally substituted heterocycles, or a combination thereof, which are linked to one or more framework metals, metal ions, or metal containing compounds through linking clusters; and wherein at least one of the linking moieties contains at least one carbene that can be metallated with a modifying metal, metal ion, or metal containing compound.

15. The framework of claim 13, wherein one or more modifying metal ions is selected from the group consisting of Li⁺, Na⁺, Rb⁺, Mg²⁺, Ca²⁺, Sr²⁺, Ba²⁺, Sc³⁺, Ti⁴⁺, Zr⁴⁺, Ta³⁺, Cr³⁺, Mo³⁺, W³⁺, Mn³⁺, Fe³⁺, Fe²⁺, Ru³⁺, Ru²⁺, Os³⁺, Os²⁺, Co³⁺, Co²⁺, Ni²⁺, Ni⁺, Pd²⁺, Pd⁺, Pt²⁺, Pt⁺, Cu²⁺, Cu⁺, Au⁺, Zn²⁺, Al³⁺, Ga³⁺, In³⁺, Si⁴⁺, Si²⁺, Ge⁴⁺, Ge²⁺, Sn⁴⁺, Sn²⁺, Bi⁵⁺, Bi³⁺.

16. The ZIF or MOF of claim 14, wherein one or more framework metal ions is selected from the group consisting of Li⁺, Na⁺, Rb⁺, Mg²⁺, Ca²⁺, Sr²⁺, Ba²⁺, Sc³⁺, Ti⁴⁺, Zr⁴⁺, Ta³⁺, Cr³⁺, Mo³⁺, W³⁺, Mn³⁺, Fe³⁺, Fe²⁺, Ru³⁺, Ru²⁺, Os³⁺, Os²⁺, Co³⁺, Co²⁺, Ni²⁺, Ni⁺, Pd²⁺, Pd⁺, Pt²⁺, Pt⁺, Cu²⁺, Cu⁺, Au⁺, Zn²⁺, Al³⁺, Ga³⁺, In³⁺, Si⁴⁺, Si²⁺, Ge⁴⁺, Ge²⁺, Sn⁴⁺, Sn²⁺, Bi⁵⁺, Bi³⁺.

17. The MOF of claim 14, wherein at least one linking moiety has the structure of: 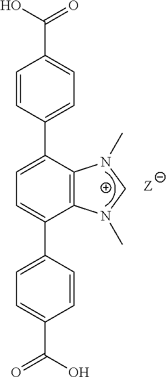
wherein Z is a counter ion.

18. The MOF of claim 17, wherein the MOF has the structure and characteristics of IRMOF-76.

19. The ZIF or MOF of claim 14, wherein the reactive carbine containing linking moiety is metallated with a modifying metal, metal ion, or metal containing compound.

20. The MOF of claim 19, wherein the MOF has the structure and characteristics of IRMOF-77.

21. A method of making the framework of claim 13 comprising reacting at least one organic-based link comprising at least one carbene and comprising a protected linking cluster with a modifying metal, metal ion, or metal containing compound to obtain a metallated linking moiety, deprotecting the linking cluster and reacting the metallated organic-based link with a framework metal, metal ion, or metal containing compound or with another organic-based link that may or may not contain a carbene.

22. A gas storage composition comprising the framework of claim 13.

23. A catalyst composition comprising the framework of claim 13.
